(19) United States
(12) Patent Application Publication
(10) Pub. No.: US 2016/0044530 A1
(43) Pub. Date: Feb. 11, 2016

(54) METHOD AND APPARATUS OF CONGESTION MANAGEMENT

(71) Applicant: Industrial Technology Research Institute, Hsinchu (TW)

(72) Inventors: Ching-Wen Cheng, Tainan City (TW); Hung-Chen Chen, Hsinchu City (TW); Tzu-Jane Tsai, Hsinchu County (TW)

(21) Appl. No.: 14/813,131

(22) Filed: Jul. 30, 2015

Related U.S. Application Data
(60) Provisional application No. 62/034,802, filed on Aug. 8, 2014.

(51) Int. Cl. H04W 28/02; H04W 28/12; H04L 12/801

(52) U.S. Cl. CPC H04W 28/0289; H04L 47/11; H04W 28/12

(57) ABSTRACT

A congestion management method is provided. The radio access node detects and determining a congestion. The radio access node performs a process of a congestion mitigation decision if the congestion is detected and determined. The radio access node performs a congestion mitigation process based on a result of the congestion mitigation decision. The radio access node detects and determines a congestion relief The radio access node stops the congestion mitigation process, and the congestion control process according to the congestion is stopped accordingly.

### CROSS-REFERENCE TO RELATED APPLICATION

This application claims the priority benefits of U.S. provisional application Ser. No. 62/034,802, filed on Aug. 8, 2014. The entirety of the above-mentioned patent application is hereby incorporated by reference herein and made a part of this specification.

### TECHNICAL FIELD

The embodiment of the disclosure generally relates to a congestion management technology.

### BACKGROUND

In a typical wireless communication system, due to limitation in available radio resources, a radio access network (RAN) user plane (UP) congestion may occur when the demand for RAN resources exceeds the available radio capacity to deliver the user data. RAN UP congestion may lead to packet drops or delays of user data. Therefore, RAN DL (Downlink) UP congestion control is an unavoidable situation since more and more users using their mobile devices for various services with heavy traffic.

### SUMMARY

Several exemplary embodiments accompanied with figures are described in detail below to further describe the disclosure in details.

An embodiment in accordance with the disclosure, a congestion management method adapted for a radio access node is provided. the method comprises: the radio access node detects and determining a congestion; the radio access node performs a process of a congestion mitigation decision if the congestion is detected and determined; the radio access node performs a congestion mitigation process based on a result of the congestion mitigation decision; the radio access node detects and determining a congestion relief; and the radio access node stops the congestion mitigation process, the congestion control process according to the congestion being stopped.

An embodiment in accordance with the disclosure, a radio access node is provided. The radio access node comprises a transceiver and a processor; the transceiver configured to transmit and receive wireless signals; The processor coupled to the transceiver and configured to detecting a congestion performing a process of a congestion mitigation decision if the congestion is detected and determined; performing a congestion mitigation process based on a result of the congestion mitigation decision, a congestion control process being performed based on the result of the congestion mitigation decision according to the congestion that has been detected and determined; and detecting a congestion relief, wherein if the congestion relief is detected and determined, sending a congestion relief message and stopping the congestion mitigation process, the congestion control process according to the congestion being stopped.

An embodiment in accordance with the disclosure, a congestion management method adapted for a user equipment (UE) is provided. The method comprises: the UE receives a congestion control message; the UE performs a congestion control process and generats a UE feedback in response to the congestion control message, wherein the UE feedback comprises at least one preference indication indicating at least a preferred target traffic of the UE.

An embodiment in accordance with the disclosure, a user equipment (UE) is provided. The UE comprises a transceiver and a processor. The transceiver configured to transmit and receive wireless signals. The processor coupled to the transceiver and configured to receiving a congestion control message, performing a congestion control process and generating a feedback in response to the congestion control message, wherein the UE feedback comprises at least one preference indication indicating at least a preferred target traffic of the UE.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A illustrates a wireless communication system according to an embodiment of the disclosure.

FIG. 1B illustrates processes of a congestion management method according to an embodiment of the disclosure.

FIGS. 2A-9D illustrate message diagrams of the congestion management method according to exemplary embodiments of the disclosure.

### DETAILED DESCRIPTION OF DISCLOSED EMBODIMENTS

The exemplary embodiments of a congestion management method in short, are introduced for the purpose of explaining the disclosure, but the disclosure is not limited thereto.

The term “eNodeB” or “eNB” in this disclosure may be a radio access node, for example, a base station (BS), a Node-B, an advanced base station (ABS), a base transceiver system (BTS), an access point, a home base station, a relay station, a scatterer, a repeater, an intermediate node, an intermediary, and/or satellite-based communication base stations, and so like. For the purpose of explaining the disclosure, “eNB” is used in the exemplary embodiments, but the disclosure is not limited thereto.

The term “user equipment” (UE) in this disclosure may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so like.

### From eNB Side:

A congestion management method comprises congestion control detection and determination may be performed based on at least one statistic collected by eNB, for example, or a radio access node. The congestion management method may further comprise congestion relief detection and determination performed based on at least one statistic collected by eNB. In an embodiment of the disclosure, the at least one statistic may be at least one of performance indications of RAN, e.g., average DL PDU (protocol data packet) drop rate of all DL flow buffers; ratio per UE that DL PDUs for the UE are successfully scheduled to DL transmission radio resource in a period of time; ratio that E-RAB/RB (E-UTRAN Radio Access Bearer/Radio Bearer) are abnormally loosed on S1/Uu interface; the throughput and DL PDU buffered delay per eNB DL buffer; each eNB DL buffer may associate to a classifier (e.g., LCG—Logical Channel Group, QCI—Quality of service Class Indicator, priority, service type, etc.).

When the congestion is detected and determined, a congestion mitigation decision process is performed so as to determine the mechanism to mitigate the RAN DL UP congestion. The congestion mitigation process may further comprise determining at least one concerned target UE and/or at least one concerned target traffic (e.g., specific IP flow(s)/RB(s) associated with the same or associated with different Services) to be de-prioritized (e.g., to be given a priority which is less precedence than the original priority) from transmission based on at least one UE characteristic and/or at least one traffic characteristics. In which, the UE characteristic may be e.g., subscriber class (e.g., platinum, gold, silver, bronze), total DL volume, UE capability (e.g., supported radio access type, capability of supporting flow based congestion control), UE radio condition (e.g., RSRP, RSRQ), and the traffic characteristics may be e.g., the flow(s)/RB(s)/Service(s) that caused congestion, priority of the flow(s)/RB(s)/Services(s) (provided by the core network or the management function of the RAN that the eNB belongs to based on operator policy), but is not limited therein.

After determining the at least one concerned UE/at least one concerned target traffic, a congestion management method which is performed may comprise one or more of the following process:, signaling or broadcasting one or more congestion control messages to the concerned UE(s), receiving the UE feedback(s), and sending one or more congestion report messages to a core network (CN). Wherein, the congestion control message sent to the concerned UE(s) may be e.g., a congestion notification to inform the occurrence of RAN DL UP congestion, may provide one or more traffic flow(s) and/or bearer(s) to the concerned UE, may indicate the concerned UE(s) to feedback one or more of the preferred traffic flow to the eNB. The concerned UE feedback may comprise e.g., one or more UE preferred traffic flow(s)/bearer(s), the one or more UE preferred traffic flow(s)/bearer(s) may be selected from the traffic flow(s)/bearer(s) that the eNB provided to the UE in the congestion control message. The congestion report message to CN may be e.g., a congestion notification to inform the occurrence of RAN DL UP congestion, may comprise one or more suggested UE(s)/traffic flow(s)/bearer(s) configurations, may bring out the CN to feedback to eNB. The CN feedback may be a response message e.g., to confirm the receiving of the congestion report message from the eNB, or to indicate the one or more UEs or traffic flow(s)/bearer(s) to be subjected to congestion control, or to set the configuration of the eNB.

Along with the determination of RAN DL UP congestion, the eNB would perform the congestion relief detection process and keep detecting the relief of RAN DL UP congestion. When the relief of RAN DL UP congestion is detected and determined, a congestion relief process may be by the eNB. The congestion relief process may comprise one or more of the following process: inform one or more UE the relief of the RAN DL UP congestion by signaling or broadcasting the congestion relief message to the UE(s), sending the congestion relief message to the CN, and stop the eNB congestion control process. Wherein, the congestion relief message sent to the one or more UE may be a notification to inform the relief of RAN DL UP congestion to the one or more UE. Afterward when congestion control process has been successfully stopped, the eNB may stop the eNB may stop the congestion relief process. The congestion relief message sent to the CN may be a notification to inform the relief of RAN DL UP congestion.

### From UE Side

A UE is allowed to specify the one or more preferred traffic flow(s) and/or bearer(s) to the eNB when the UE received congestion control message from the eNB.

More specifically, in one embodiment, after receiving the congestion control message from the eNB, the UE may performs a UE feedback process by e.g., determining/selecting at least one or more of the preferred traffic flow(s)/bearer(s), the one or more preferred traffic flow(s)/bearer(s) may be selected according to the attended or unattended of traffic flow(s)/bearer(s) (e.g., the traffic flow(s) associated with the application service running on the foreground or background of the UE, respectively), or the priority of the traffic flow(s)/bearer(s) (e.g., pre-configured by CN or by RAN, or pre-configured by the user of the UE). In addition, the preferred traffic flow(s)/bearer(s) may be determined/selected from the traffic flow(s)/bearer(s) given by the eNB. Alternatively, UE(s) may specify the preferred traffic flow(s)/bearer(s) before receiving the Congestion Control Message. For example, specify the preferred service(s) when in RRC_CONNECTED state by the RRCConnectionSetupComplete message or the UECapabilityInform message. The UE feedback may be event-triggered or periodically in which the event-triggered UE feedback may be triggered (by e.g., the receiving of Congestion Control Message from eNB, or according to the change of the attended traffic flow(s)/bearer(s)), and the frequency or numbers of the periodical UE feedback should be limited e.g., by a threshold.

After receiving the congestion relief message from the eNB, the UE may stop the UE side RAN DL UP congestion process by releasing the restriction of RAN DL UP congestion e.g., UE stops determining/selecting preferred flow(s)/bearer(s), or the UE may stop UE feedback process by stopping sending the preference traffic flow(s)/bearer(s) to the network, or the UE may send pending service request.

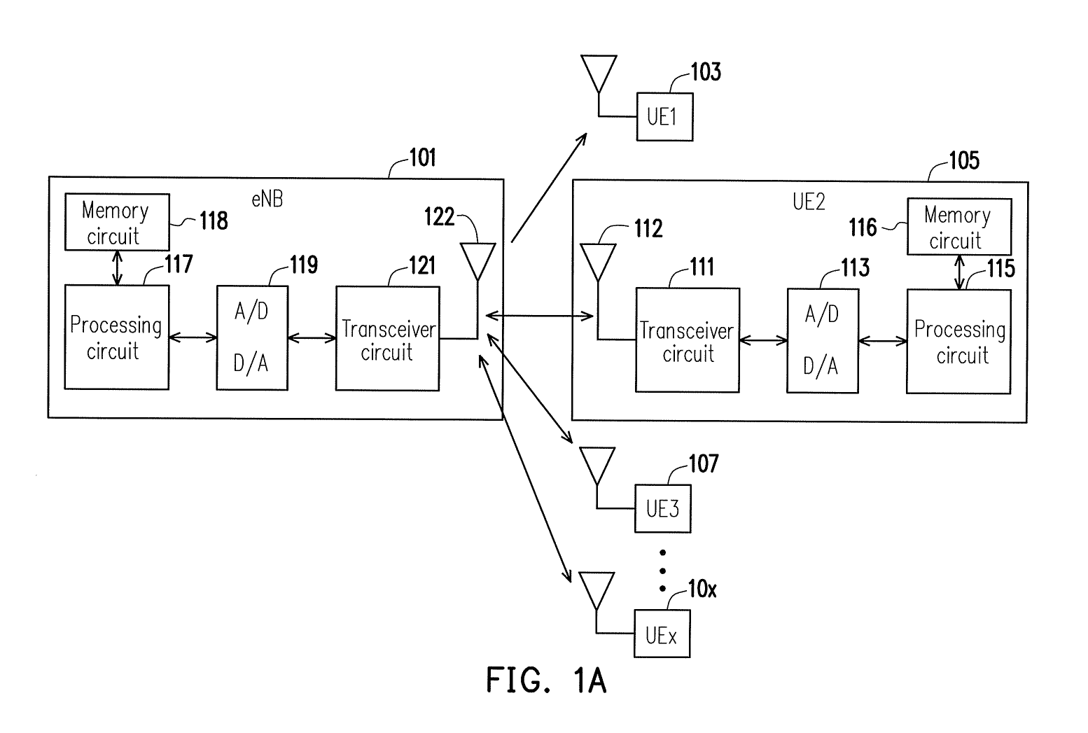

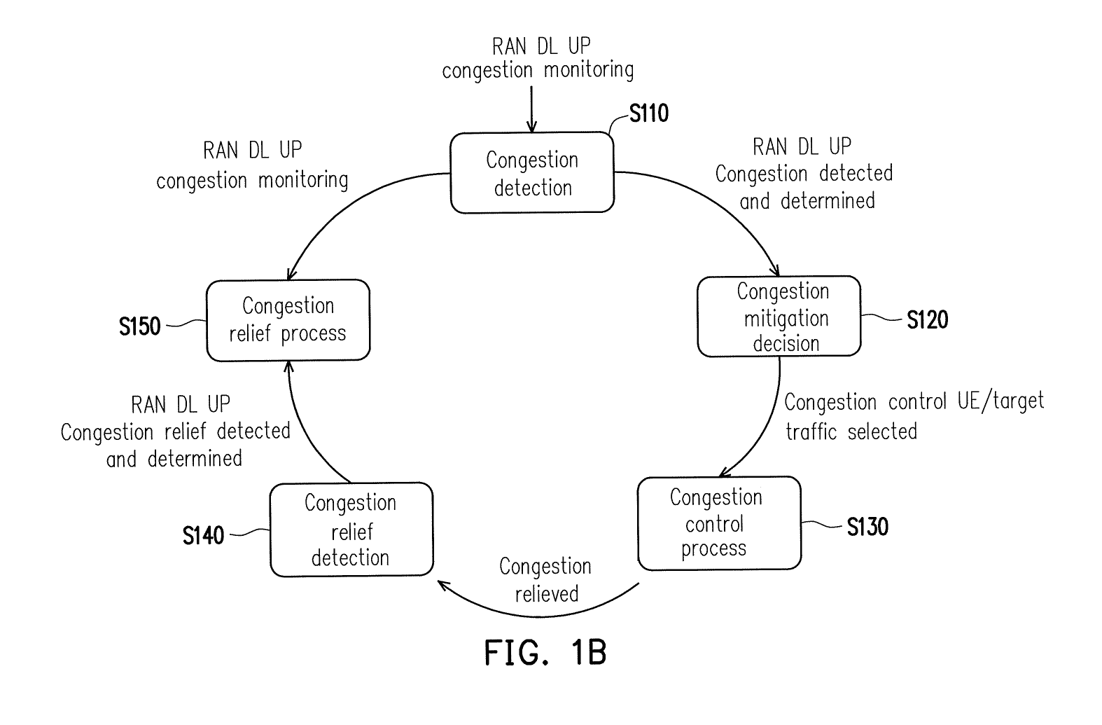

FIG. 1A illustrates a wireless communication system according to one of the exemplary embodiments. The wireless communication system includes an eNB (101) in communication with at least one UE (103, 105, . . . 10x) in accordance with a wireless communication standard. Each UE contains, for example, at least a transceiver circuit (111), an analog-to-digital (A/D)/ digital-to-analog (D/C) converter (113), and a processing circuit (115). The transceiver circuitry (111) is capable of transmitting uplink signal and/or receives downlink signal wirelessly. The transceiver circuitry (111) may also perform operations such as low noise amplifying, impedance matching, frequency mixing, up or down frequency conversion, filtering, amplifying, and so like. The transceiver circuitry (111) also includes an antenna unit (117). The analog-to-digital (A/D)/digital-to-analog (D/C) converter (113) is configured to convert from an analog signal format to a digital signal format during downlink signal processing and digital signal format to analog signal format during uplink signal processing. The processing circuit (115) is configured to process digital signal and to perform procedures of the proposed method for data transmission in accordance with exemplary embodiments of the present disclosure. Also, the processing circuit (115) may include a memory circuit (116) to store data or record configurations assigned by the eNB (101). The eNB (101) contains similar elements including a transceiver unit (121) and an analog-to-digital (A/D)/digital-to-analog (D/C) converter (119) which lead to the converted digital signal to be processed by its processing circuitry (117) as well as using the memory circuit (118) so as to implement the method for data transmission in accordance with exemplary embodiments of the present disclosure.

FIG. 1B illustrates a congestion management method according to an exemplary embodiment of the disclosure. According to the embodiment shown in FIG. 1B, the congestion management method begins at step S110 with performing a congestion detection to detect the occurrence of RAN DL UP congestion by e.g., monitoring at least one of the performance indications of RAN. The performance indications of RAN may be at least one of e.g., an average DL PDU drop rate of all DL flow buffers, a ratio per UE that DL PDUs for the UE are successfully scheduled to DL transmission radio resource in a period of time, a ratio that E-RAB/RB are abnormally loosed on S1/Uu interface, a throughput and DL PDU buffered delay per eNB DL buffer, each eNB DL buffer may associate to a classifier (e.g., LCG, QCI, flow priority, service type, etc.).

If the RAN DL UP congestion is detected and determined, a congestion mitigation decision process S120 is performed to determine the mechanism to mitigate the RAN DL UP congestion, the mechanism to mitigate the RAN DL UP congestion may include e.g., decreasing the available radio resource per UE for a portion or all of the UEs served by the eNB, or blocking the transmission of the data packets associated to the bearers with low priority, or dropping data packets associated to the bearers with low priority. The determination of the mechanism to mitigate the RAN DL UP congestion may be according to the policy and rules configured in the eNB. The policy and rules may be configured from the core network (e.g., from an OAM server of the core network) to the eNB. The congestion mitigation decision process may further comprise the process that the eNB selects at least a concerned UE and/or at least a concerned target traffic to be de-prioritized, in which the concerned target traffic(s) may be at least one of specific IP flow, E-RAB, RB(Radio Bearer), or service flow. In detail, the eNB selects the concerned UE(s) and/or concerned target traffics) based on the concerned UE characteristic(s) and/or the traffic characteristic(s). In an embodiment of the disclosure, the UE characteristic(s) include, for example, a subscriber class (e.g., platinum, gold, silver, bronze), a total DL volume, UE capability (e.g., supported radio access type, a capability of supporting flow based congestion control), UE radio condition (e.g., RSRP, RSRQ), but are not limited thereto. The traffic characteristic(s) are e.g., at least one of flow, RB, or service that caused congestion, or e.g., priority of the traffic flow(s), E-RABs, RB(s), or service flow(s) provided by the core network or the management function of the RAN that the eNB belongs to based on operator policy, but are not limited thereto. For example, in an exemplary implementation of congestion mitigation decision, the eNB is supposed to maintain an UE context of each UE, in which the UE context may comprise an UE ID, subscriber class, the bearer ID and associated QCI and/or LCG of each bearer (may include one of the following type of bearer: RB, E-RAB, EPS bearer), the flow ID and the associated bearer ID of each flow, traffic characteristic(s) of each flow (e.g., priority, service identity, protocol identifier, port number, application identifier, streaming, interactive, best effort, etc.). For instance, all of the UEs which are in “Bronze” subscriber class are considered as concerned UE(s), or all of the best effort traffic flow(s) are considered as concerned traffic(s). The eNB enables a Classifier_{congestion}(e.g., Classifier_{congestion} could be a functional entity of eNB to classify incoming traffic. Classifier_{congestion} could be disabled/enabled dynamically by the eNB) for DL congestion traffic filtering. The Classifier_{congestion} filters best effort traffic flow(s), and the eNB selects all the UE(s) that the best effort traffic flow(s) filtered by the Classifier_{congestion} associated to as concerned UE(s).

When the congestion mitigation mechanism has been determined in S120, the congestion mitigation process is determined, a congestion control process S130 is performed according to the mitigation mechanism determined in S120. The congestion control process S130 may further comprise sending congestion report message to the CN and/or sending/broadcasting a congestion control message to the UE(s) with a result of the congestion mitigation decision S120. The congestion control messages sent/broadcasted to the concerned UE may be a congestion control notification to inform the occurrence of the RAN DL UP congestion, may provide traffic flow(s) and/or bearer(s) to concerned UE(s) for notifying the concerned UE(s) to follow the congestion control or for the concerned UE(s) to select and feedback the preferred traffic flow(s)/bearer(s), or may indicate the concerned UE(s) to feedback the preferred traffic to the eNB. Similarly, the congestion report message sent to the CN may be a congestion control notification to inform the occurrence of RAN DL UP congestion, may comprise the suggested UE/traffic flow/bearer configurations, or may bring out CN to feedback to eNB. In addition, CN may also feedback the CN adopted UE/traffic flow/bearer configurations to eNB.

In the step of congestion control process S130, the eNB may further receive the UE feedback from a concerned UE. The UE feedback may comprise the UE preferred traffic flow(s)/bearer(s), furthermore, the UE preferred traffic flow(s)/bearer(s) may be selected from the traffic flow(s)/bearer(s) that eNB provided for the UE to select.

Step S140 involves detecting a congestion relief by e.g., monitoring at least one of the performance indications of RAN which are similar to thereof in the step of congestion detection S110. Along the eNB has detected and determined the occurrence of RAN DL UP congestion, the eNB would keep monitoring the performance indications of RAN and determine whether the RAN DL UP congestion has been relieved.

After RAN DL UP congestion relief is detected and determined, the eNB performs a congestion relief process S150. In the congestion relief process S150, the eNB stops the congestion control process. The eNB may further inform the relief of RAN DL UP congestion to the UE(s), or to the CN, or to both the UE and CN. The UE(s) which the eNB informs for RAN DL UP congestion relief may include the UE(s) impacted by the RAN DL UP congestion, or the UE(s) selected by the eNB, or all the UE(s) served by the eNB. The eNB may signal or broadcast the congestion relief message to UE. The congestion relief message may be a notification to inform the relief of RAN DL UP congestion.

The congestion relief process S150 may further comprise that the eNB sends the congestion relief message to the CN in which the congestion relief message may be a notification to inform the relief of RAN DL UP congestion in the eNB. Afterward when the eNB completing the congestion relief process S150, the eNB congestion relief process is stopped.

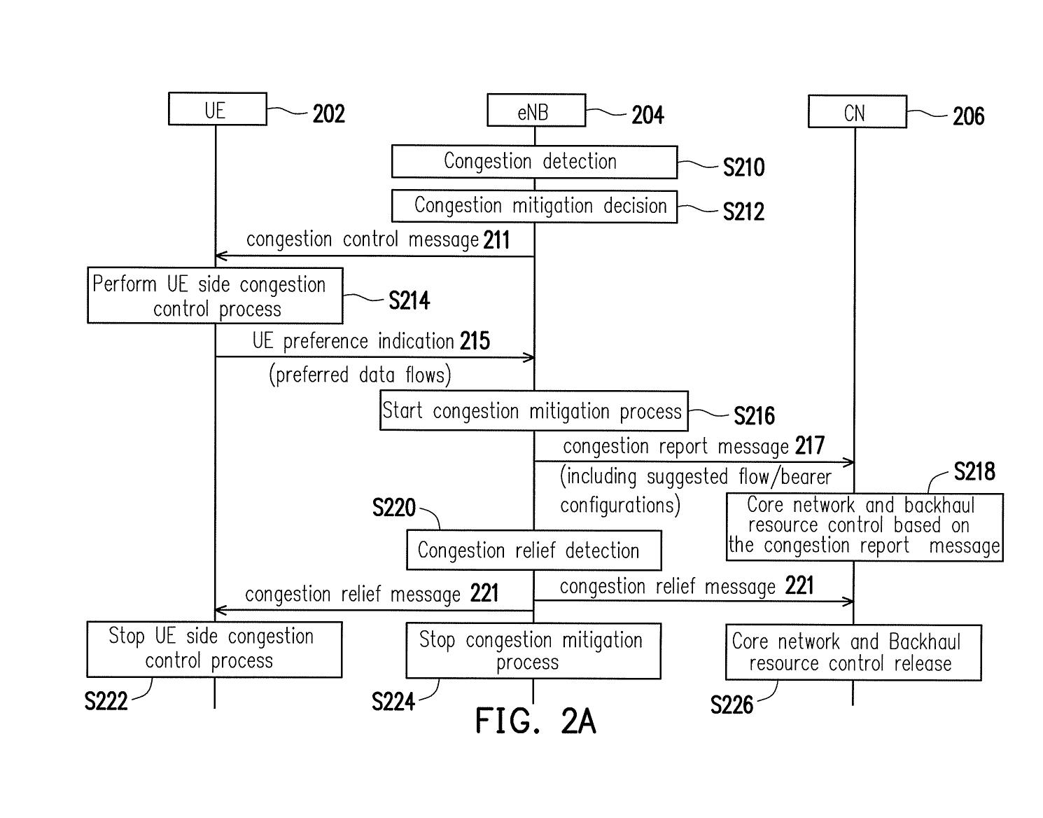

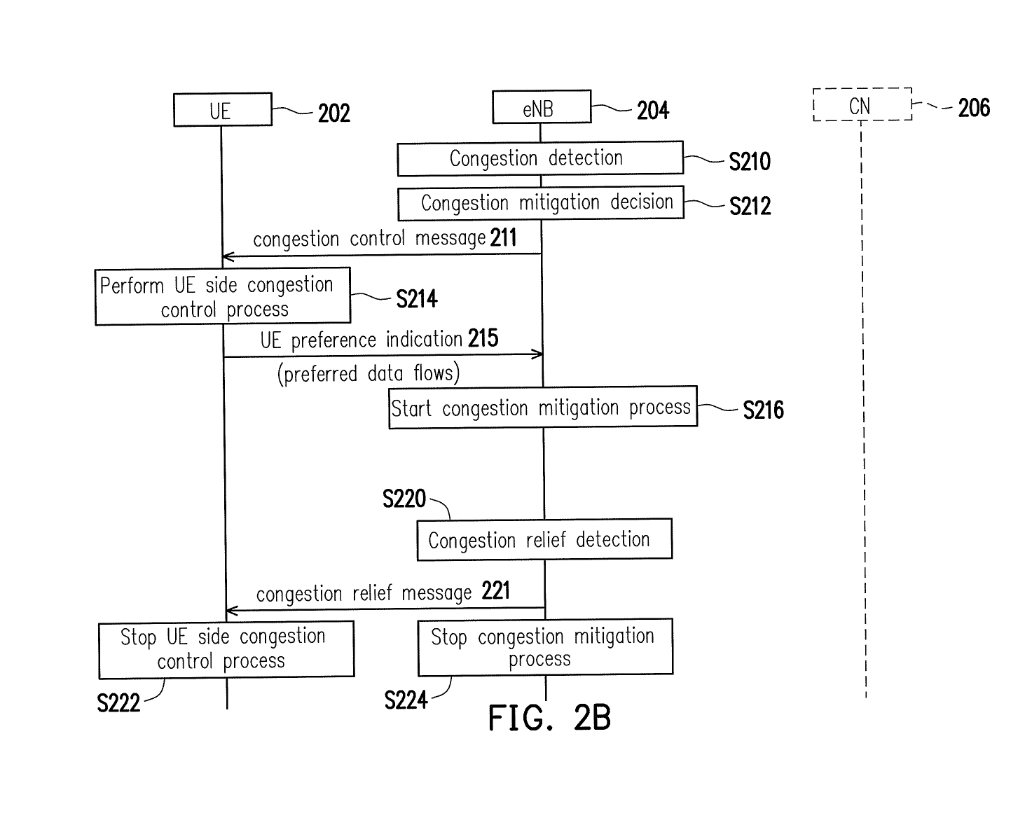

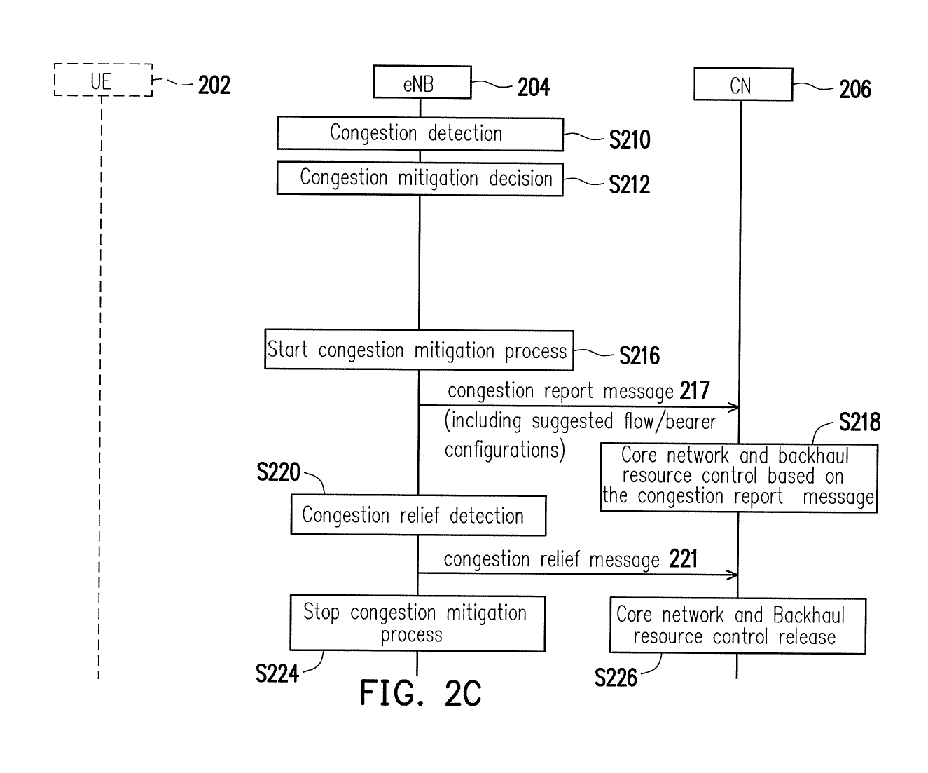

FIG. 2A illustrates a message diagram of one exemplary embodiment of a congestion management method with considering the congestion control processes S214 and S218 in UE and CN sides, respectively. As shown in FIG. 2A, the eNB 204 firstly monitors the performance parameters and metrics of RAN DL UP congestion. When the eNB detects one or more of the performance indications of RAN DL UP congestion exceed the pre-defined threshold in step S210, for instance, when the required PRB outpaces the available PRBs for a time threshold, and/or the DL PDU drop rate is above a pre-defined threshold, the eNB 204 may determine that the DL congestion is occurred.

Upon the eNB 204 determines the occurrence of RAN DL UP congestion, it performs a congestion mitigation decision process S212 to determine the mechanism to mitigate the RAN DL UP congestion. The congestion mitigation decision process S212 may further comprise that the eNB selects the concerned UE(s) and/or the concerned traffic flow(s)/bearer(s) to be de-prioritized based on the UE characteristic(s) and/or the traffic characteristic(s). For example, the eNB 204 may select the UE(s) associate with the best effort traffic flow(s) as the concerned UE(s) 202 or the UE(s) with total traffic volume exceeding a pre-defined threshold as the concerned UE(s) 202.

In one embodiment of FIG. 2A, after performing the process of congestion mitigation decision S212, the eNB 204 sends a congestion control message 211 which may be a congestion notification to the concerned UE(s) 202. Upon receiving the congestion control message 211, the UE 202 would perform an UE side congestion control process S214 accordingly, i.e., comply with operator policy (e.g., prevent sending Service Request or request for establishing new PDN connections). In one embodiment of FIG. 2A, the UE 202 may further select the preferred traffic flow(s) of the UE and send a UE preference indication 215 to the eNB 204, where the UE preference indication 215 may indicate the preferred traffic flow(s)/bearer(s) of the UE 202. In an embodiment of the disclosure, the UE 202 may send multiple UE preference indications 215 to the eNB 204. For example, upon the event takes place (e.g., the expiry of a pre-defined or pre-configured timer, or the change of attended/foreground service/traffic flow) to trigger the UE 202 to select and send the UE preference indication. The UE 202 may send the UE preference indication 215 to the eNB 204 periodically in which the frequency of sending the UE preference indication (feedback) would be restricted (e.g., by a threshold of the time interval between the sending of two UE preference indication). In one embodiment, the UE is capable of sending at least one UE feedback in response to the congestion control message.

In one embodiment of the disclosure, upon receiving the UE preference indication 215 sent from the UE 202, the eNB 204 may prioritize the traffic flow(s)/bearer(s) included in the UE preference indication for the UE 202 accordingly. For example, the eNB 204 may consider to prioritize and transmit the DL traffic flow(s)/bearer(s) included in the UE preference indication sent from the UE 202 while de-prioritize other traffic flow(s)/bearer(s) of the UE 202, and may for example, suspend and/or throttle (i.e., not to transmit the data packets in a period of time, and/or to reduce the frequency or the amount of data packets transmitted) the de-prioritized traffic flow(s)/bearer(s) of the UE 202.

After prioritizing the data flow(s), the eNB 204 starts a congestion mitigation process S216 to determine the mechanism to mitigate the RAN DL UP congestion. In one embodiment of the disclosure, the eNB 204 could send a congestion report message 217 to the CN 206 (e.g., to P-GW or PCRF or RCAF (Radio Congestion Awareness Function)) to suggest the corresponding UE/traffic flow/bearer configurations. In an embodiment of the disclosure, the eNB 204 may send multiple congestion report messages 217 with different parameter values to CN 206 during the RAN DL UP congestion period.

Upon receiving the congestion report message 217 from the eNB 204, the CN 206 may perform a core network and backhaul resource control based on the congestion report message 217 and the parameters and values of the congestion report message 217 from the eNB 204 such that the data packets associated with de-prioritized traffic flow(s)/bearer(s) would not be transmitted via the backhaul to the eNB 204 with considering that the data packets associated de-prioritized traffic flow(s)/bearer(s) might eventually be dropped due to the RAN DL UP congestion.

The eNB 204 would keep monitoring the performance indications of RAN and find out whether the congestion relief is detected and determined in the congestion relief detection step S220. When congestion relief is determined, the eNB 204 could send the congestion relief message 221 to both the UE 202 and the CN 206 in order to release the congestion control in UE 202 and in the CN 206. The UE 202 and the CN 206 would release the RAN DL UP congestion control based on the receiving of the congestion relief message 221 accordingly.

In step S224, the eNB 204 stops the RAN DL UP congestion mitigation procedure when all the RAN DL UP congestion control of CN and UE(s) are released.

Finally, in steps 222 and 226, the UE 202 and the CN 206 would respectively stop the UE side congestion control process and the CN side congestion control process by i.e., recovering the original configurations of the UE 202 and CN 206.

FIG. 2B illustrates a message diagram of one exemplary embodiment of a congestion management method without considering congestion control process in CN side. According to FIG. 2B, the processes for managing congestion in the eNB 204, the UE 202, and the communication procedures between the eNB 204 and the UE 202 are similar to thereof of the embodiment shown in FIG. 2A, thus they are not repeated herein. The key difference is that this embodiment does not rely on the CN side congestion control process. In detail, after starting congestion mitigation process S216, the eNB may not send the congestion report message to the CN 206. Similarly, instead of sending the congestion relief message to both the concerned UE 202 and the CN 206 when the relief of congestion is detected and determined, the eNB 204 sends the congestion relief message 221 to the concerned user UE 202.

FIG. 2C illustrates a message diagram of one exemplary embodiment of a congestion management method without considering congestion control process in UE side. According to FIG. 2C, the processes for managing congestion in the eNB 204, the CN 206, and the communication procedures between the eNB 204 and the CN 206 are similar to thereof of the embodiment shown in FIG. 2A, thus it is not repeated herein. However, this embodiment does not rely on the UE side congestion control process. More specifically, after performing the congestion mitigation decision process S212 to determine the concerned UE and/or concerned target traffic(s), the eNB 204 starts performing congestion mitigation process S216 without the necessity of sending the congestion control message to the concerned UE nor waiting for the feedback from the concerned UE. The eNB 204 may send congestion report message 217 to the CN 206. The eNB 204 performs congestion relief detection process S220 to detect and determine the relief of RAN DL UP congestion. Additionally, when the relief of congestion is detected and determined, the eNB 204 sends the congestion relief message 221 to the CN 206.

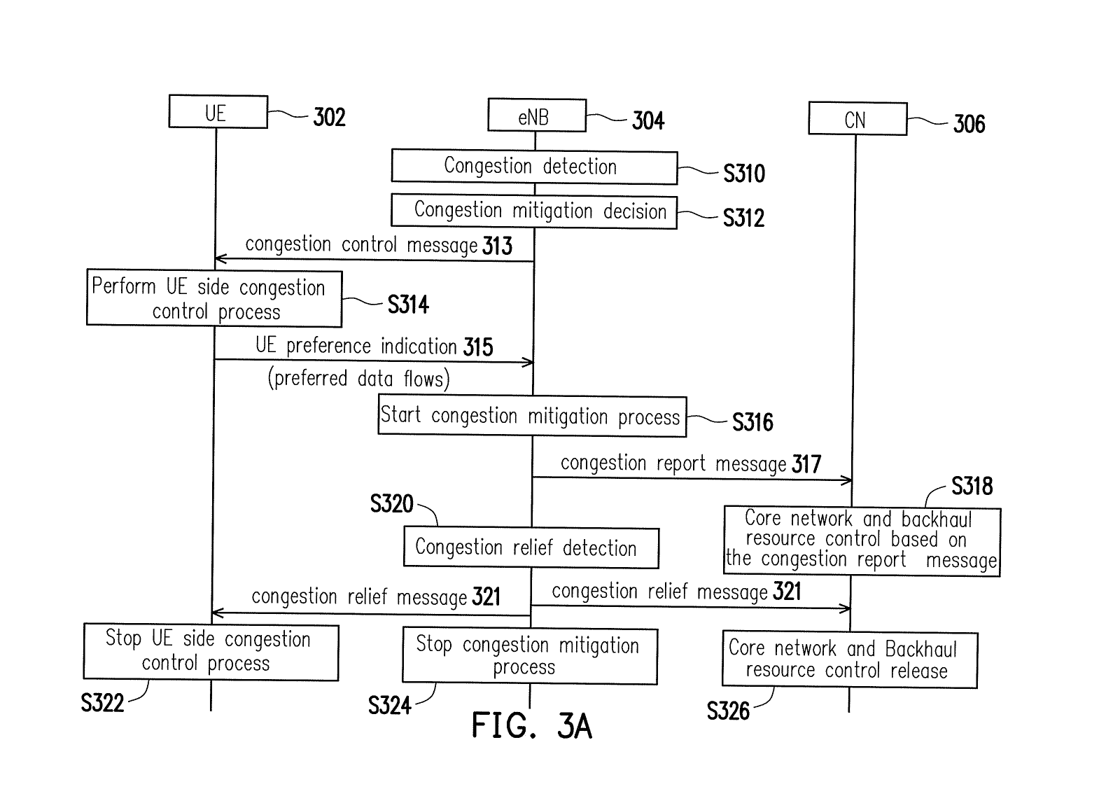

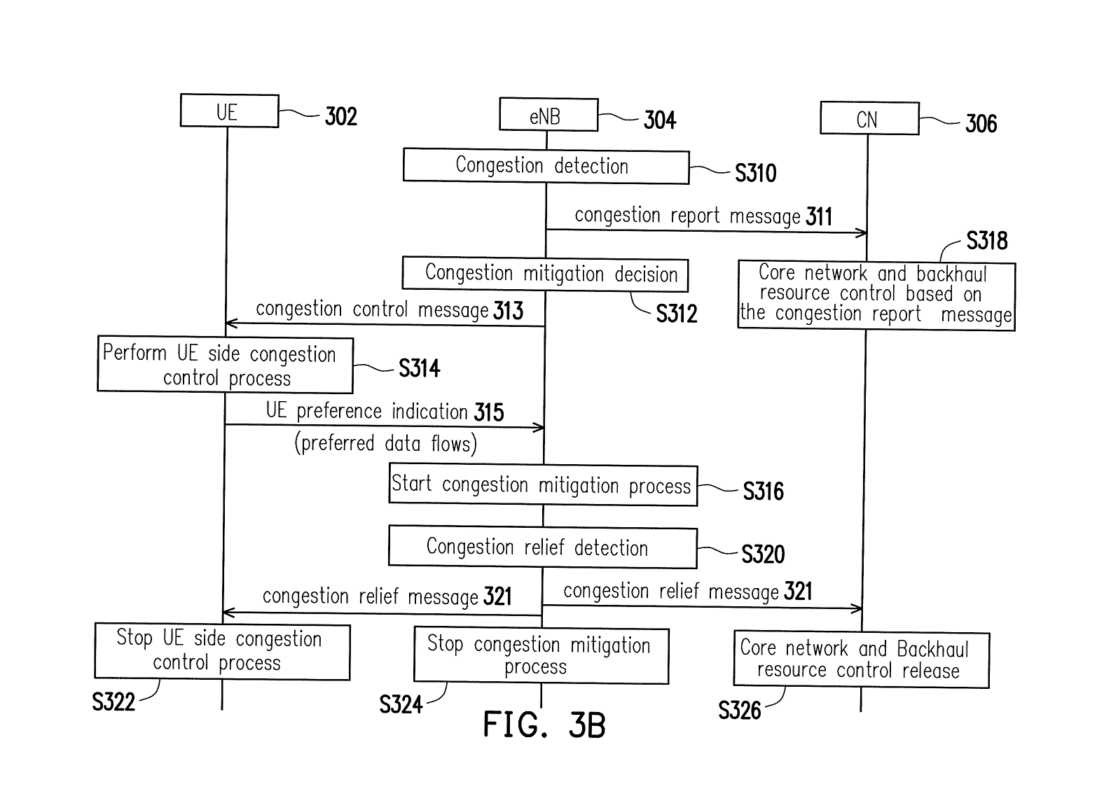

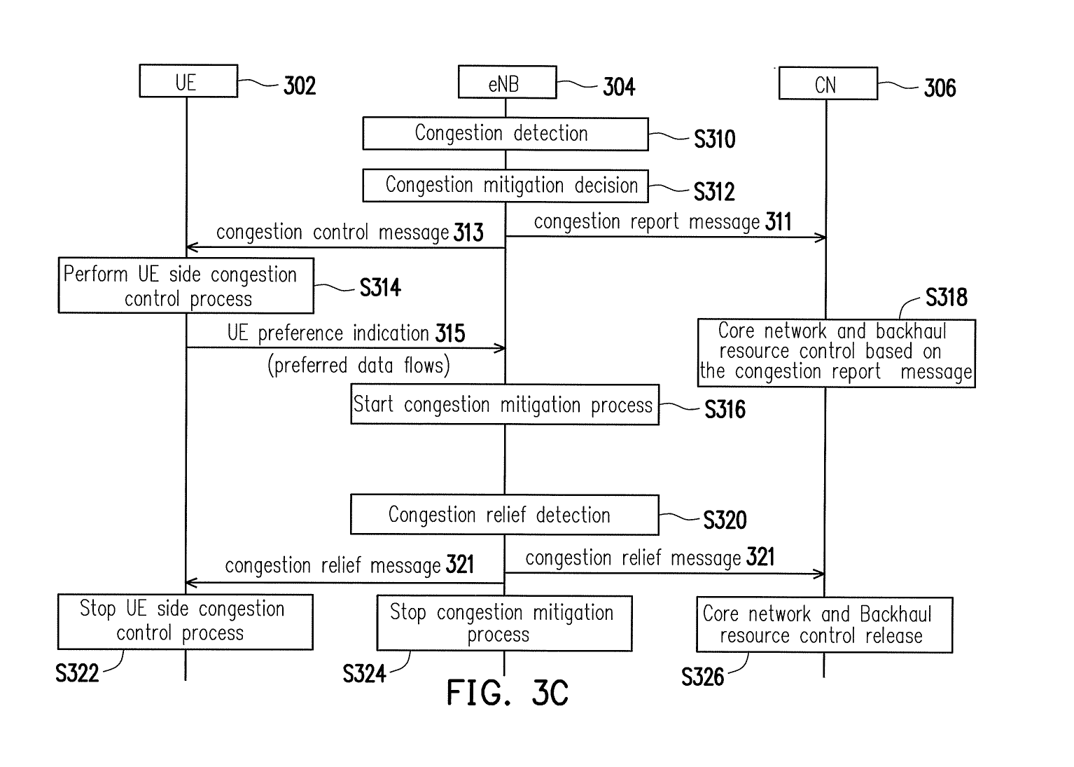

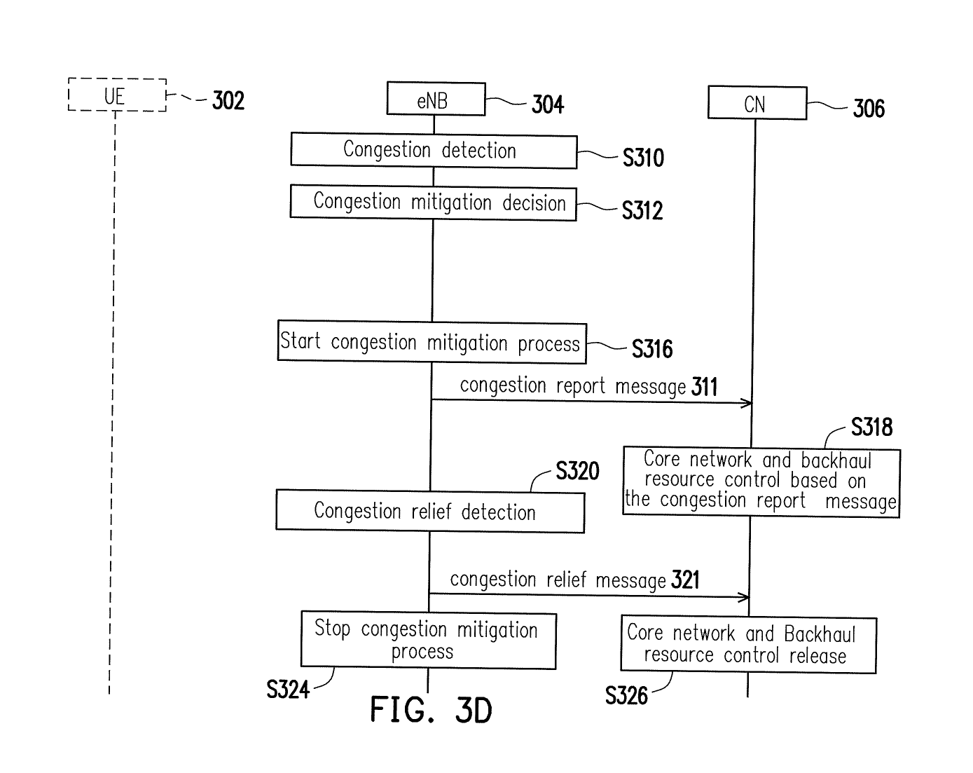

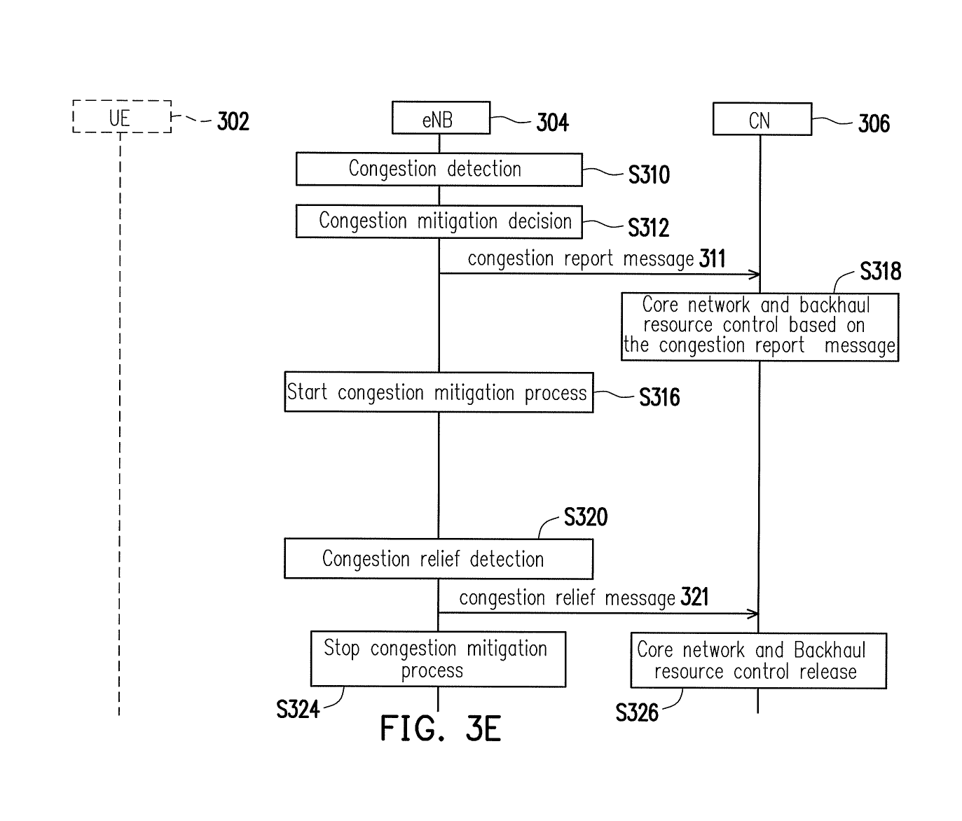

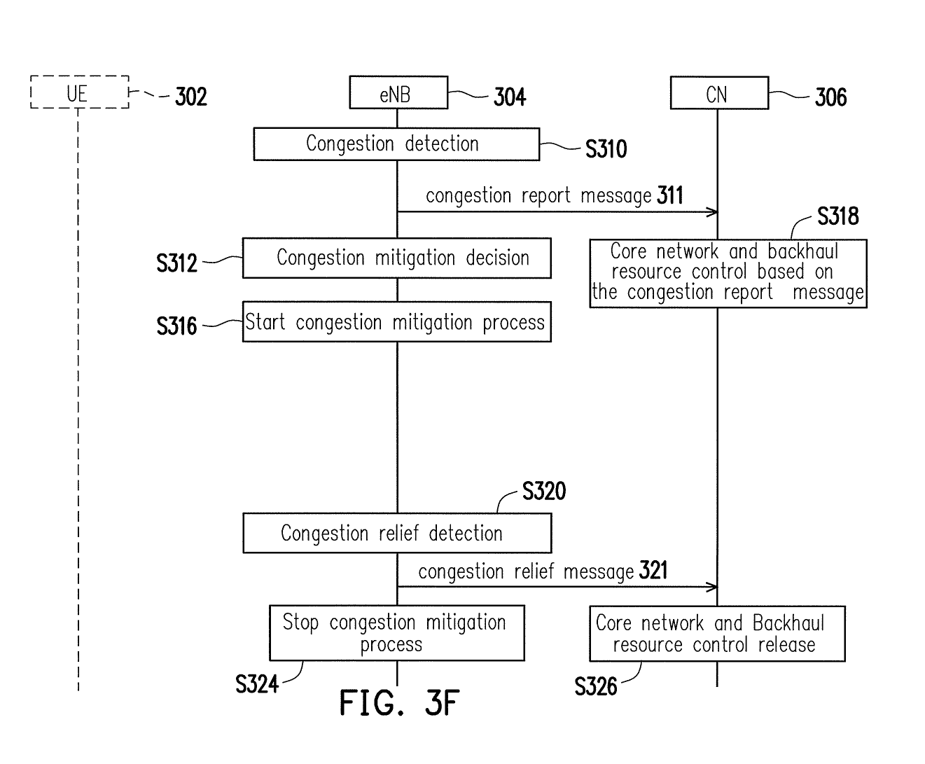

FIG. 3A illustrates a message diagram of congestion management method according to another exemplary embodiment of the disclosure. FIG. 3A illustrates a message diagram of one exemplary embodiment of a congestion management method with considering congestion control processes S314 and S318 in UE and CN sides respectively, where the congestion report message 317 without including suggested traffic flow/bearer configurations from eNB is sent to CN after performing the congestion mitigation process S316. Referring to FIG. 3A, some steps of the congestion management method in this embodiment are similar to thereof shown in FIG. 2A. The difference relies on the congestion report message 317 sent from the eNB 304 to the CN 306, in which the congestion report message 321 does not include the eNB 304 suggested traffic flow/bearer configurations to the CN 306. In detail, upon receiving the UE preference indication 315 which indicates the preferred traffic flow(s)/bearer(s) from the concerned UE 302, the eNB 304 starts the congestion mitigation process S316 to determine a mechanism to mitigate the RAN DL UP congestion and sends the congestion report message 321 to the CN 306. However, the congestion report message 321 sent from the eNB 304 to the CN 306 does not include the suggested traffic flow/bearer configurations for the CN 306. And accordingly, after receiving the congestion report message 321 without suggested traffic flow/bearer configurations from the eNB 304, the CN 306 may perform core network and backhaul resource control based on the congestion report message 321, may include suspend and/or throttle the data packets associated with the traffic flow(s)/bearer(s) be transmitted to the eNB 304.

FIG. 3B illustrates a message diagram of congestion management method according to another exemplary embodiment of the disclosure. FIG. 3B illustrates a message diagram of one exemplary embodiment of a congestion management method with considering involving the congestion control processes S314 and S318 in UE and CN sides respectively, wherein the congestion report message 311 without including suggested traffic flow/bearer configurations is sent from eNB 304 to CN 306 after a congestion is detected and determined in the process of congestion detection S310. As shown in FIG. 3B, some steps of the congestion management method in FIG. 3B are similar to thereof shown in FIG. 3A. However, the time point when the congestion report message 311 is sent to the CN 306 is different. In detail, the embodiment shown in FIG. 3B the congestion report message 311 is sent from the eNB 304 to the CN 306 right after the congestion is detected and determined in step S310, instead of waiting for the UE preference indication 315 from the concerned UE 302, starting the congestion mitigation process S316, and then sending the congestion report message 317 to the CN 306 as in FIG. 3A. Accordingly, the CN 306 may perform the backhaul resource control based on the received congestion report message 311 from the eNB 304.

FIG. 3C illustrates a message diagram of congestion management method according to another exemplary embodiment of the disclosure. FIG. 3C illustrates a message diagram of one exemplary embodiment of a congestion management method with considering involving the congestion control processes S314 and S318 in UE and CN sides respectively. Some steps of the congestion management method as shown in FIG. 3C are similar to thereof shown in FIG. 3A. However, the congestion report message 311 could be sent after the eNB 304 deciding the method to mitigate the congestion in the process of congestion mitigation decision S312 as the disclosure shown in FIG. 3C.

FIGS. 3D-3F show congestion management methods according to the different embodiments of the disclosures without considering the UE side congestion control process, and in which the congestion report message is sent from the eNB 304 to the CN 306 in different time points. FIG. 3D illustrates a message diagram of one exemplary embodiment of a congestion management method without considering congestion control processes in UE side, where in the congestion report message 311 without including suggested traffic flow/bearer configurations is sent from eNB 304 to CN 306 after a congestion mitigation process S316 is started. FIG. 3E illustrates a message diagram of one exemplary embodiment of a congestion management method without considering congestion control processes in UE side, where in the congestion report message 311 without including suggested traffic flow/bearer configurations is sent from eNB to CN after a congestion mitigation method is determined in the process of congestion mitigation decision S312. FIG. 3F illustrates a message diagram of one exemplary embodiment of a congestion management method without considering congestion control processes in UE side, where in the congestion report message 311 without including suggested traffic flow/bearer configurations is sent from eNB to CN after the RAN DL UP congestion is detected and determined in the process of congestion detection S310.

Specifically, in FIG. 3D, after the RAN DL UP congestion is detected and determined by the eNB 304 in S310, and the congestion mitigation method is decided by the eNB in the congestion mitigation process S316, and the eNB 304 starts the congestion mitigation process S316, the eNB 304 may then send the congestion report message 311 to the CN 306. In the embodiment shown in FIG. 3E, the eNB 304 may send the congestion report message 311 to the CN 306 after the congestion mitigation method is decided by the eNB 304 in the process of congestion mitigation decision S312. In FIG. 3F, the eNB 304 may send the congestion report message 311 to the CN 306 after the RAN DL UP congestion is detected and determined by the eNB in congestion detection process S310.

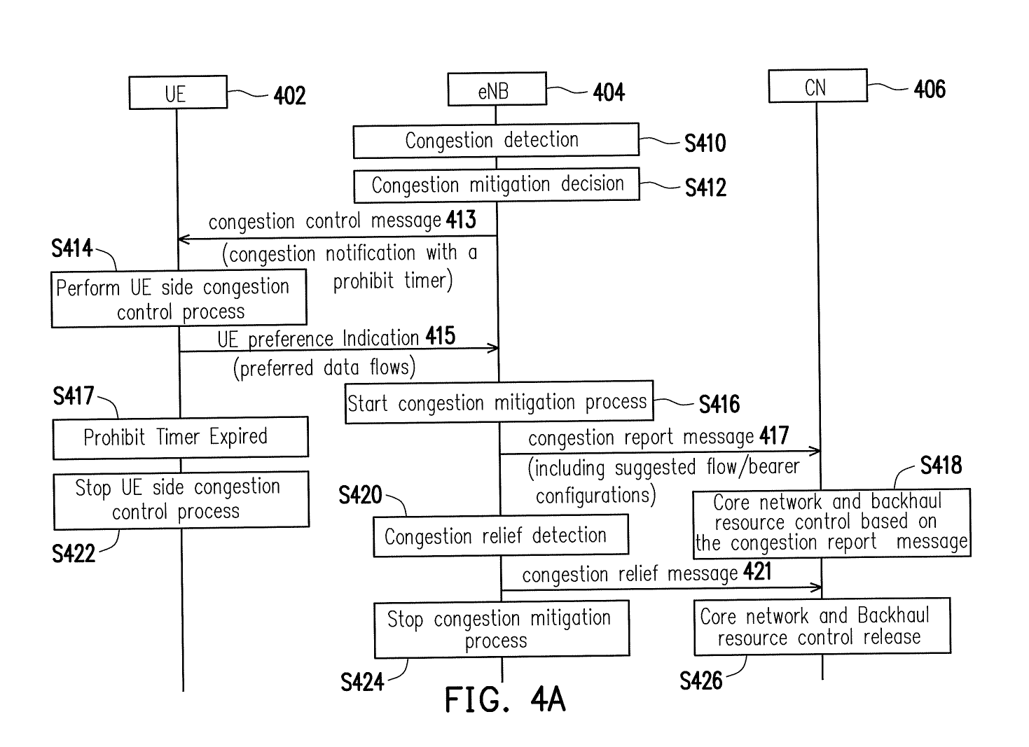

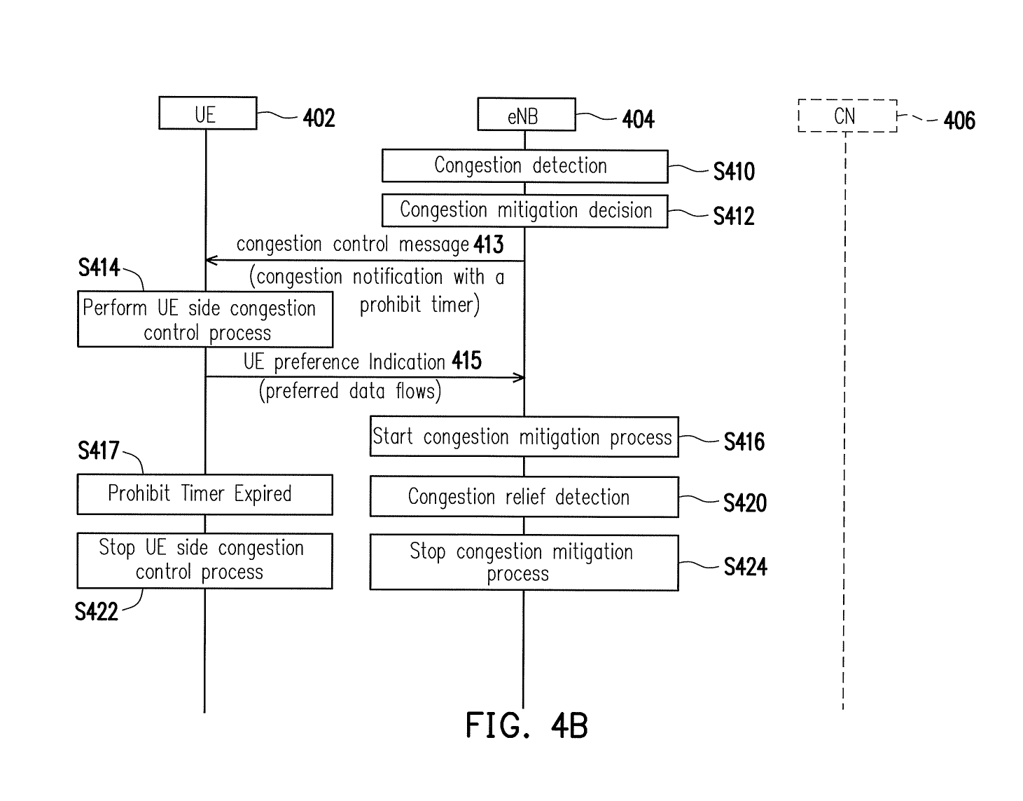

FIG. 4A shows a congestion management method according to another embodiment of the disclosure. FIG. 4A illustrates a message diagram of one exemplary embodiment of a congestion management method with considering the congestion control processes S414 and S418 in UE and CN sides respectively, where in the congestion control message 413 sent from the eNB 404 to UE 402 including a first timer, for example, a prohibit timer to indicate the maximum period of time the UE 402 should be subjected to UE side congestion control. The UE side congestion control may include UE behaviour restriction, e.g., the UE 402 should not request for new services unless the UE received the indication from eNB to release the restriction or after the expiry of the first timer. The value of the first timer could be provided by the eNB 404 in the congestion control message 413, or pre-defined in the UE 402, or pre-configured from the eNB to the UE 402, or pre-configured form the CN to the UE 402.

According to FIG. 4A, most parts of the FIG. 4A can be referred from FIG. 2A. However, in FIG. 4A the congestion control message 413 sent from the eNB 404 to the concerned UE 402 is included a first timer (e.g., a prohibit timer) which defined the maximum period of time allowed for the concerned UE 402 to perform the UE side congestion control process S414. After receiving the congestion control message 413 including the first timer (i.e., prohibit timer), the concerned UE 402 performs the UE side congestion control process S414, and may further feedback the UE preference indication 415 to the eNB 404 during the period that the first timer (i.e., prohibit timer) has not expired. When the first timer (i.e., prohibit timer) is expired, the UE side congestion control process S414 is terminated by e.g., release the restriction of sending requests for new services, or recovering the original configuration of the concerned UE as the configuration the concerned UE 402 used before receiving the congestion control message 413. Considering the UE side congestion control process S414 could be terminated according to the expiry of the first timer (i.e., prohibit timer) indicated in the congestion control message 413, the congestion relief message sent from the eNB 404 to the UE 402 for terminating the UE side congestion control process S414 may not be necessary if the RAN DL UP congestion relief is not detected and determined by the eNB 404 before the expiry of the first timer (i.e., prohibit timer).

In another embodiment of the disclosure, as shown in FIG. 4B, it illustrates a message diagram of one exemplary embodiment of a congestion management method without considering the congestion control process in CN side 406, where in the congestion control message 413 sent from the eNB 404 to the UE 402 including a first timer, e.g., a prohibit timer. In FIG. 4B, the congestion management method is similar to thereof of the embodiment shown in FIG. 4A, except that the CN side congestion control procedure is not considered. In detail, after starting and performing the congestion mitigation process S416, the eNB does not send the congestion report message to the CN 406, furthermore after the relief of the congestion is detected and determined in the congestion relief detection procedure S416, the eNB 404 does not send the congestion relief message to the CN 406.

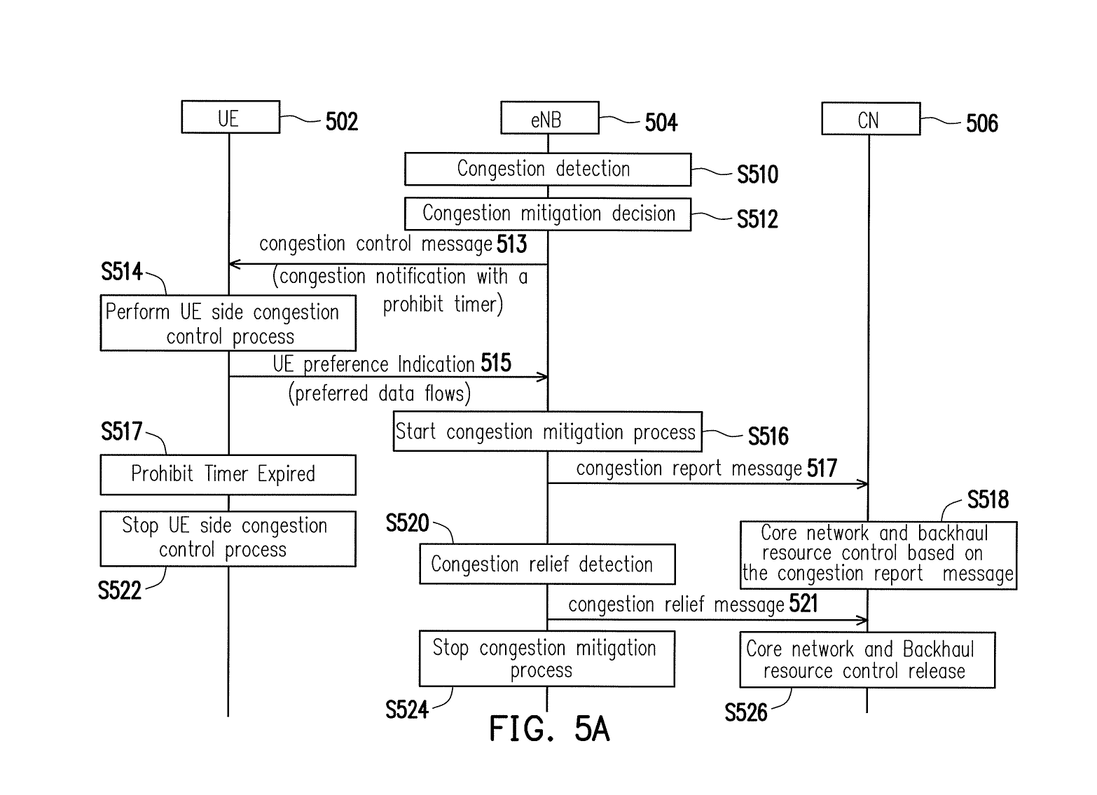

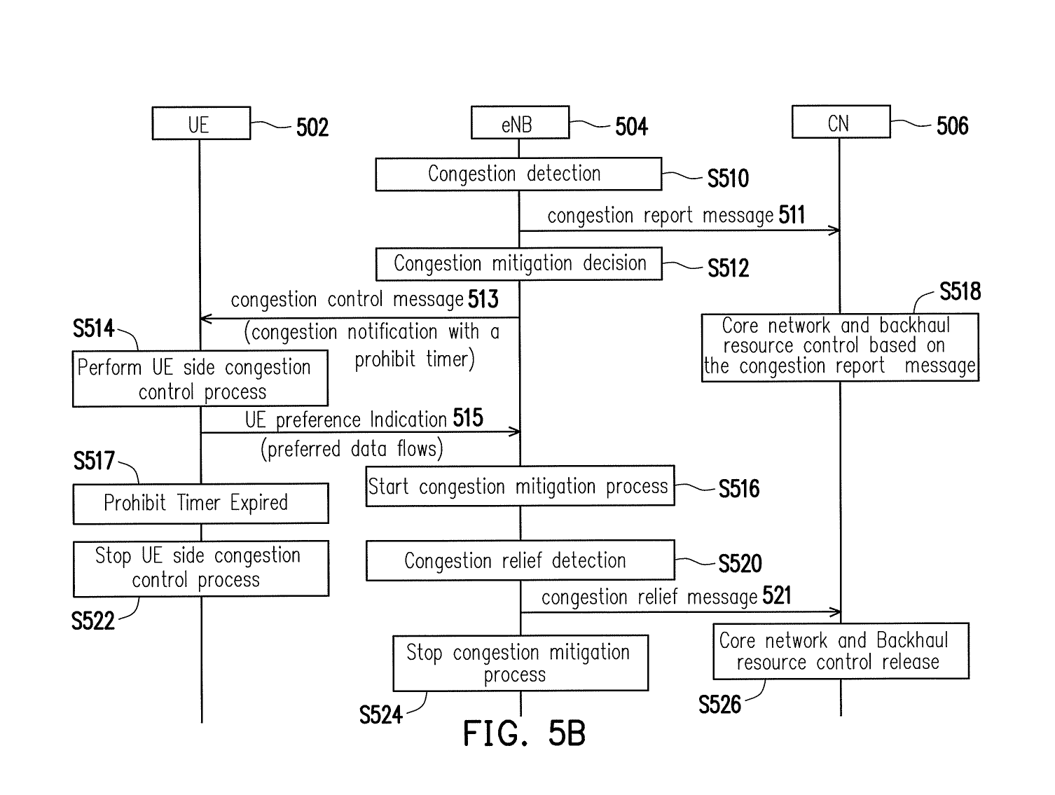

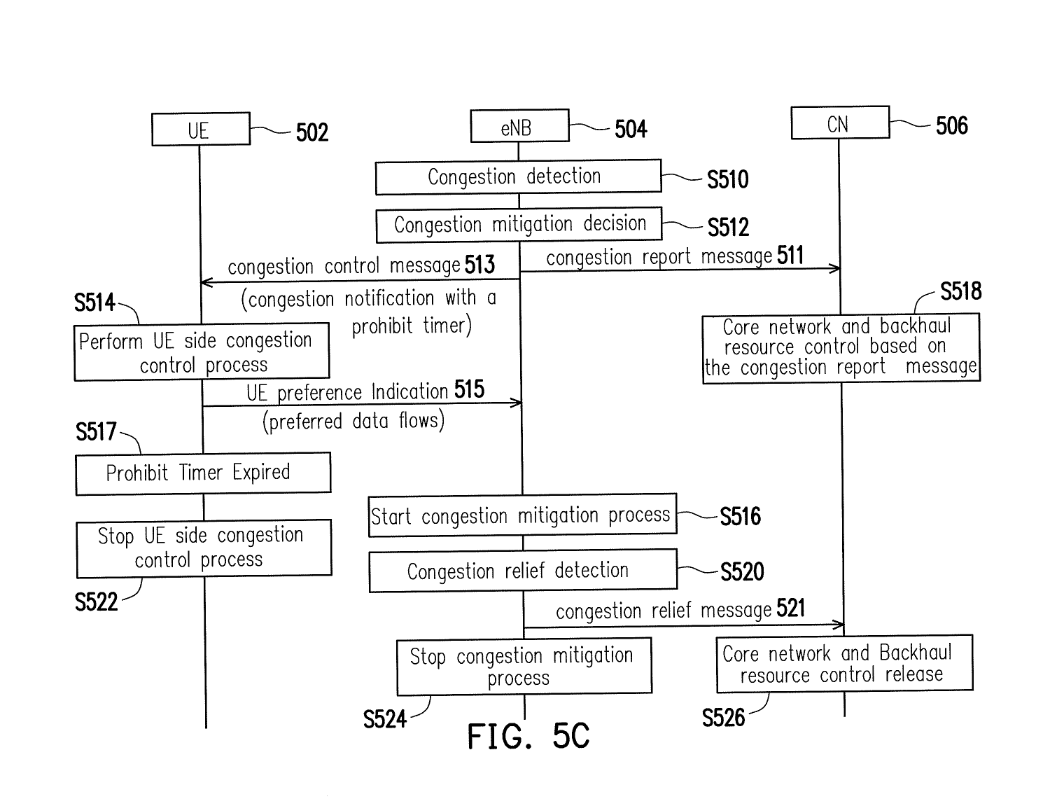

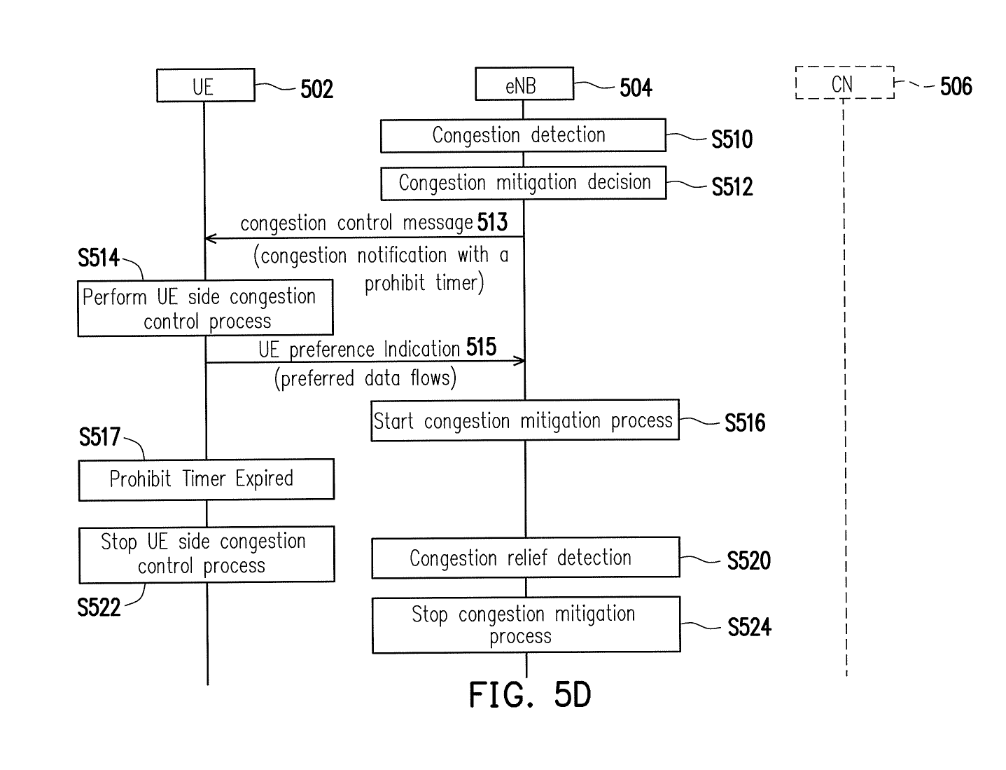

Please refer to FIG. 5A, which illustrates a message diagram of one exemplary embodiment of a congestion management method with considering congestion control processes S514 and S518 in UE 502 and CN 506 sides respectively, where in a congestion control message 513 is sent from eNB 504 to UE 502 including a first timer (e.g., prohibit timer) and a congestion report message 517 without including suggested traffic flow/bearer configurations is sent from eNB to CN 506 after the congestion mitigation method is determined by the eNB 504 in the congestion mitigation process S512. There is a miner difference of the embodiment shown in FIG. 5A in comparison to in the embodiment shown in FIG. 4A. More specifically, the difference between the embodiment shown in FIG. 4A to thereof shown in FIG. 5A is that the congestion report message 517 sent from the eNB 504 to the CN 506 in FIG. 5A does not include the suggested traffic flow/bearer configurations. The CN 506 may perform the core network and backhaul resource control in S518 based on the congestion report message 517 without suggested traffic flow/bearer configuration from the eNB 504.

In an embodiment shown in FIG. 5B, which illustrates a message diagram of one exemplary embodiment of a congestion management method with considering the congestion control processes S514 and S518 in UE 502 and CN 506 respectively, where in congestion control message 513 is sent from eNB 504 to UE 502 including a first timer (e.g., a prohibit timer) and the congestion report message 517 without including suggested traffic flow/bearer configurations is sent from eNB 504 to CN 506 after the congestion mitigation method is determined by the eNB 504 in the congestion detection process S516. In FIG. 5B, the congestion report message 511 without including suggested traffic flow/bearer configuration is sent to the CN 506 after the RAN DL UP congestion is detected and determined by the eNB 504 in the congestion detection process S510.

In another embodiment of the disclosure as shown in FIG. 5C, which illustrates a message diagram of one exemplary embodiment of a congestion management method with considering the congestion control processes S514 and S518 in UE 502 and CN 506 respectively, wherein a congestion control message 513 is sent from the eNB 504 to the UE 502 includes a first timer (e.g., a prohibit timer) and a congestion report message 511 without including suggested traffic flow/bearer configurations from eNB 504 to CN 506 after the congestion mitigation method is determined in the congestion mitigation decision process S512.

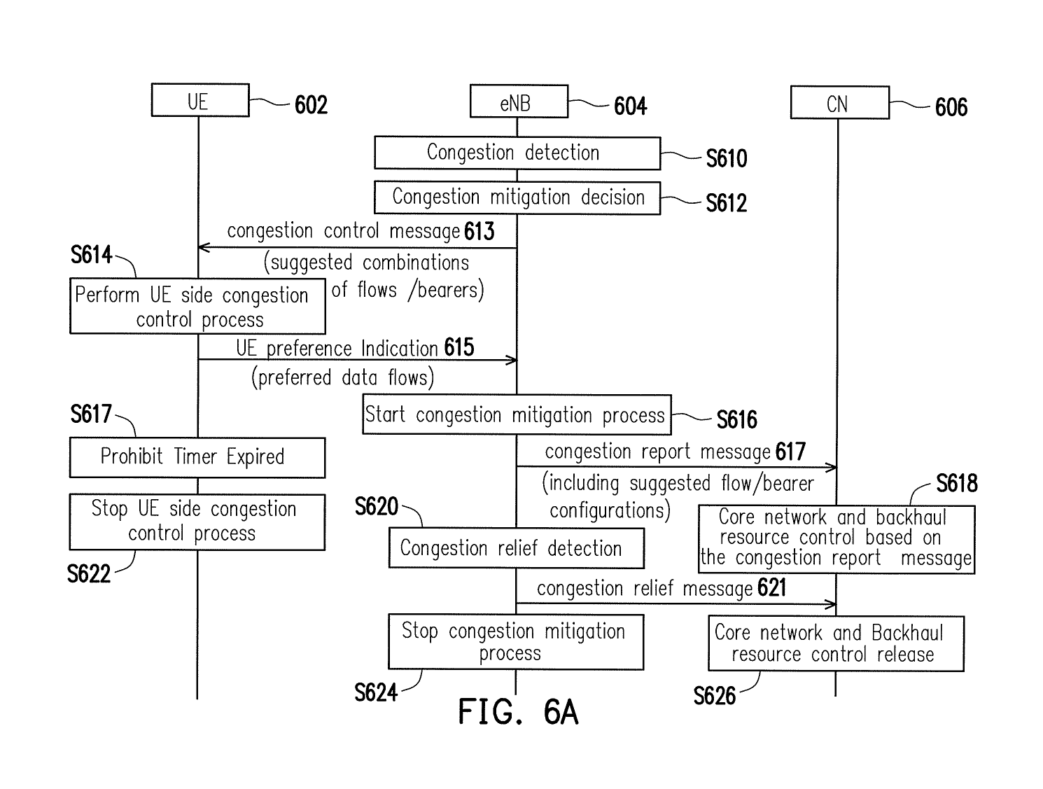

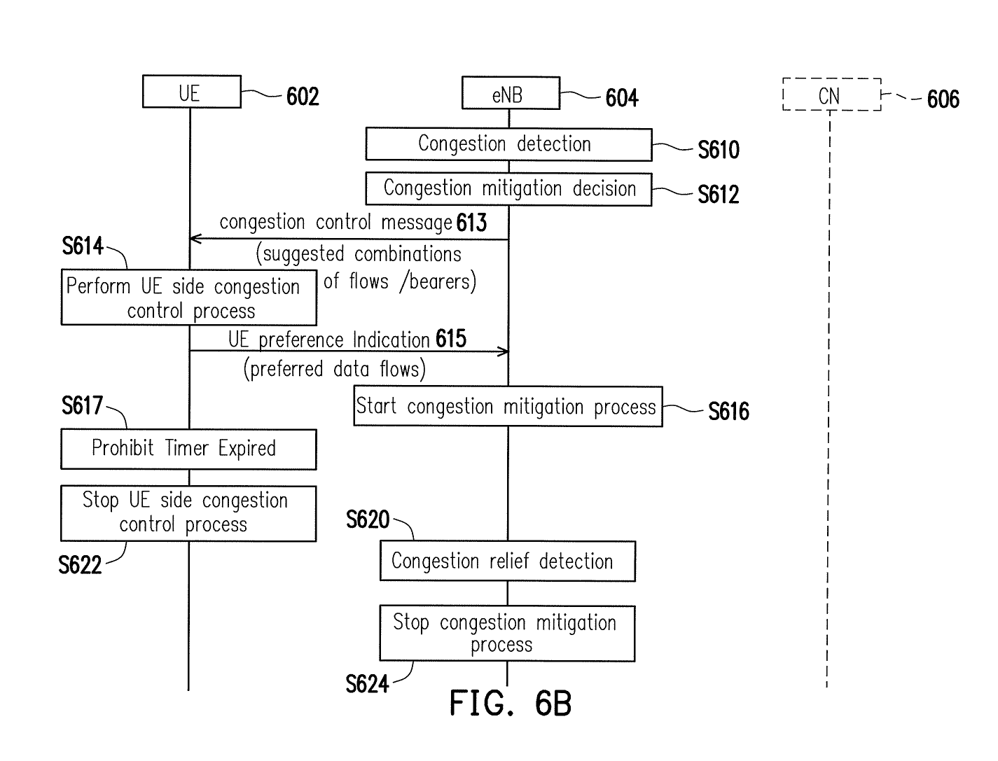

Another embodiment of the disclosure as shown in FIG. 6A. In FIG. 6A, it illustrates a message diagram of one exemplary embodiment of a congestion management method with considering the congestion control processes S614 and S618 in UE 602 and CN 606 respectively, where in the congestion control message 613 is sent from eNB 604 to UE 602 including a first timer (e.g., a prohibit timer) and the congestion report message 617 sent from eNB 604 to CN 606 including suggested traffic flow/bearer configurations.

In FIG. 6A, there are large number of processes and steps which are similar to the embodiment shown in FIG. 5A. The difference parts are in the congestion control message 613 sent from the eNB 604 to the concerned UE 602, the congestion report message 617 sent from the eNB 604 to the CN 606, and the process for checking whether the UE first internal timer (e.g., an internal prohibit timer) is expired. In detail, the congestion control message 613 includes suggested combinations of traffic flow(s)/bearer(s), the combination may comprise the UE's traffic flow(s) and/or bearer(s) selected by the eNB 604 to be subjected to congestion control.

Upon receiving the congestion control message 613 from the eNB 604, the concerned UE 602 may start a first internal timer (e.g., an internal prohibit timer) and the concerned UE would perform the congestion control process S614 accordingly when the first internal timer (i.e., internal prohibit timer) has not expired. Moreover, the concerned UE 602 can select preferred traffic flow(s)/bearer(s) from the combination given from eNB 604 and send a UE preference indication 615 to indicate the preferred traffic flow(s)/bearer(s) of the UE 602 to eNB 604. A second internal timer (e.g., internal timer_2) may be used to prevent too frequent or too many signaling that may worsen the congestion. For example, the second internal timer (i.e., internal timer_2) is reset every time when the UE preference indication message 615 is sent by the UE 602 to the eNB 604 according to a congestion control message 613 received by the UE 602 from the eNB 604, and the UE shall not send other UE preference indication message 615 before the expiry of the second internal timer (i.e., internal timer_2). When the first internal timer (i.e., internal prohibit timer) is expired S617, the concerned UE stops UE side congestion control process S622, even the concerned UE has not received a congestion relief message 621 before the expiry of the first internal timer (i.e., internal prohibit timer). Additionally, in comparing to the embodiment shown in FIG. 5A, the congestion report message 617 sent from the eNB 604 to the CN 606 includes the suggested traffic flow/bearer configurations to the CN 606 in this embodiment.

FIG. 6B shows another embodiment of the disclosure which is similar to the embodiment shown in FIG. 6A, except that the CN side congestion control process is not considered. In FIG. 6B, it illustrates one exemplary embodiment of a congestion management method without considering the congestion control processes in the CN 606, where in the UE 602 a first internal timer (e.g., internal prohibit timer) is used. The eNB 604 may not need to send the congestion report message 617 and/or the congestion relief message 621 to the CN 606.

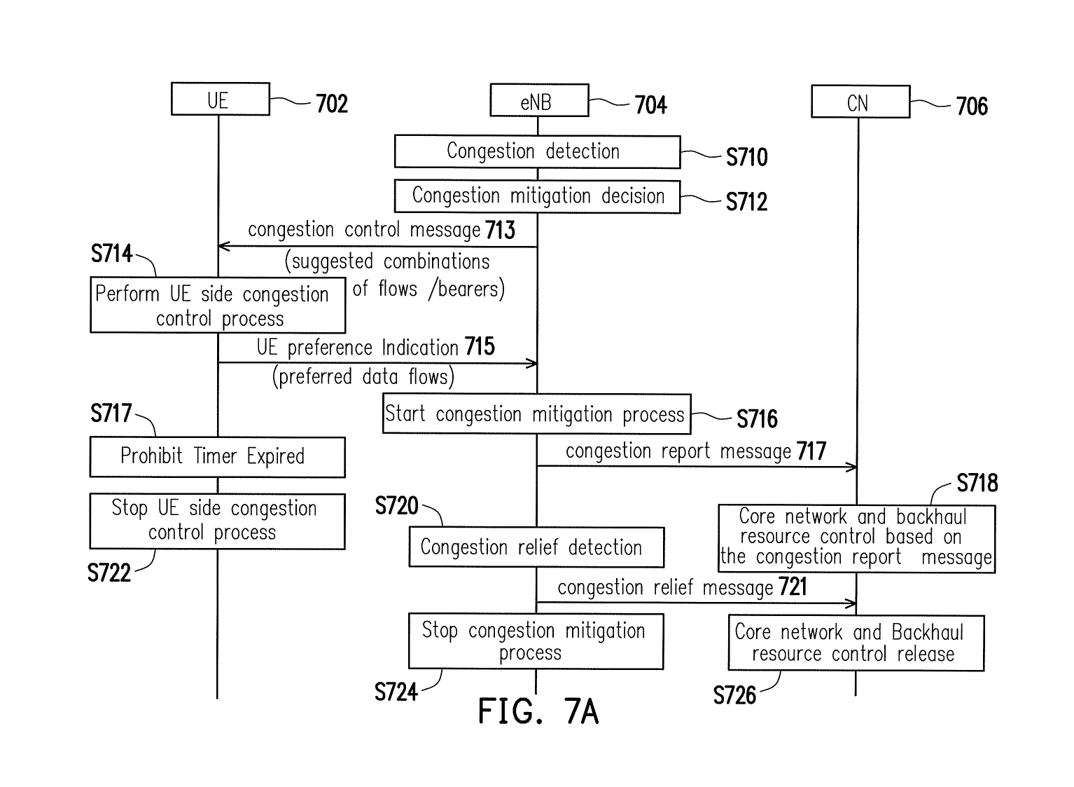

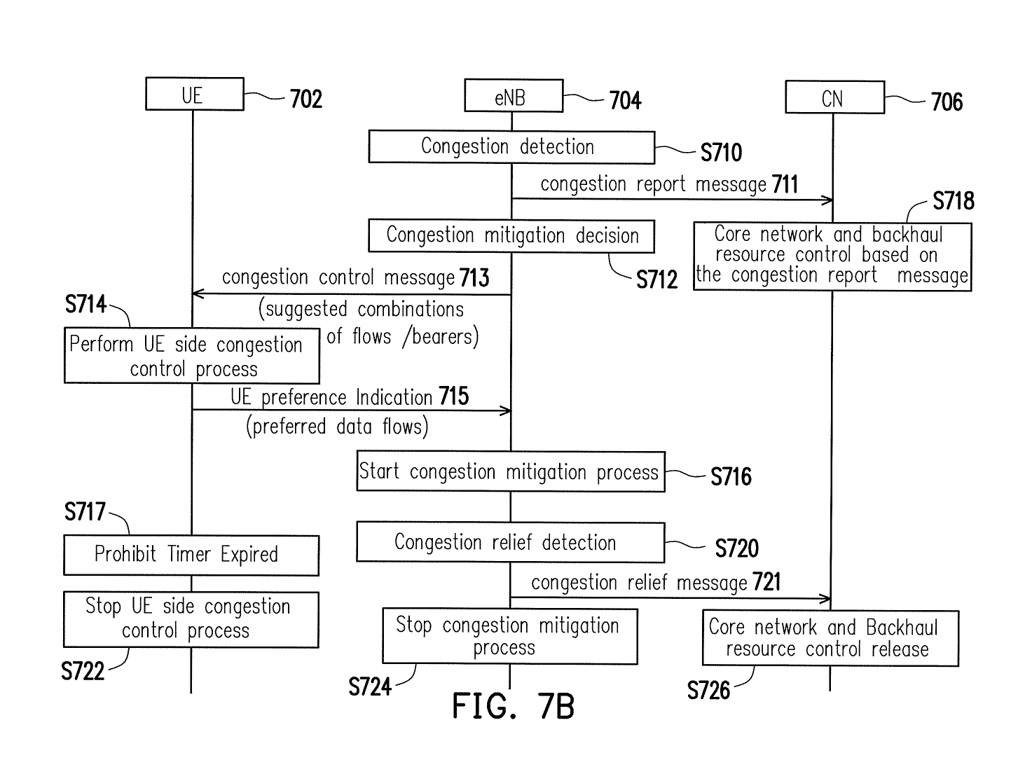

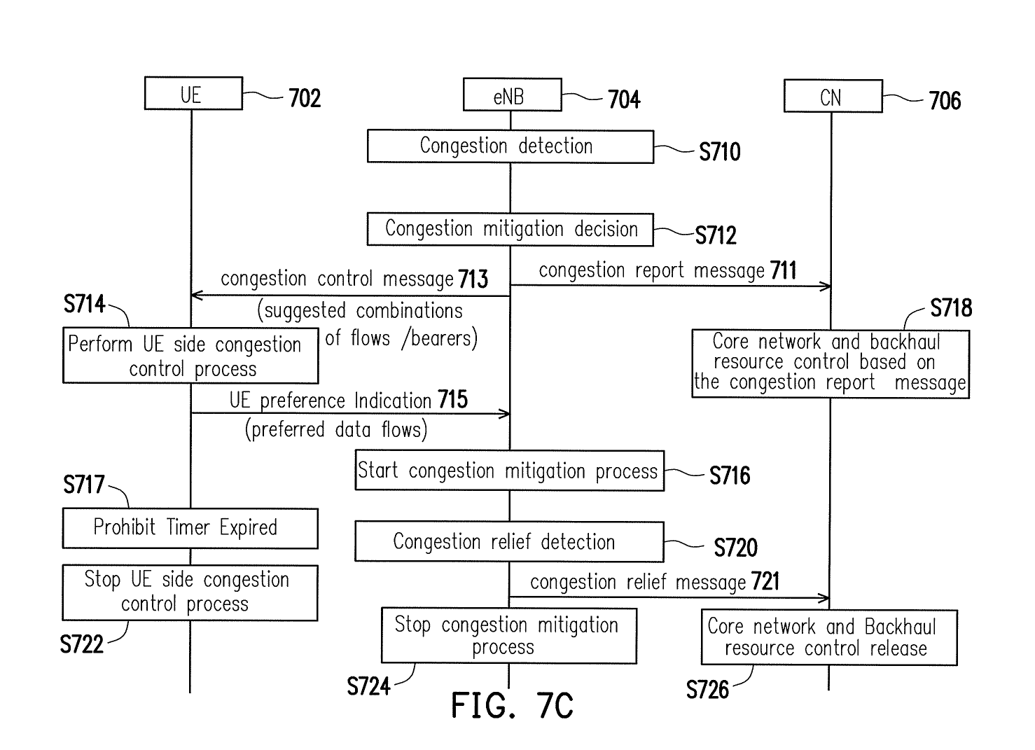

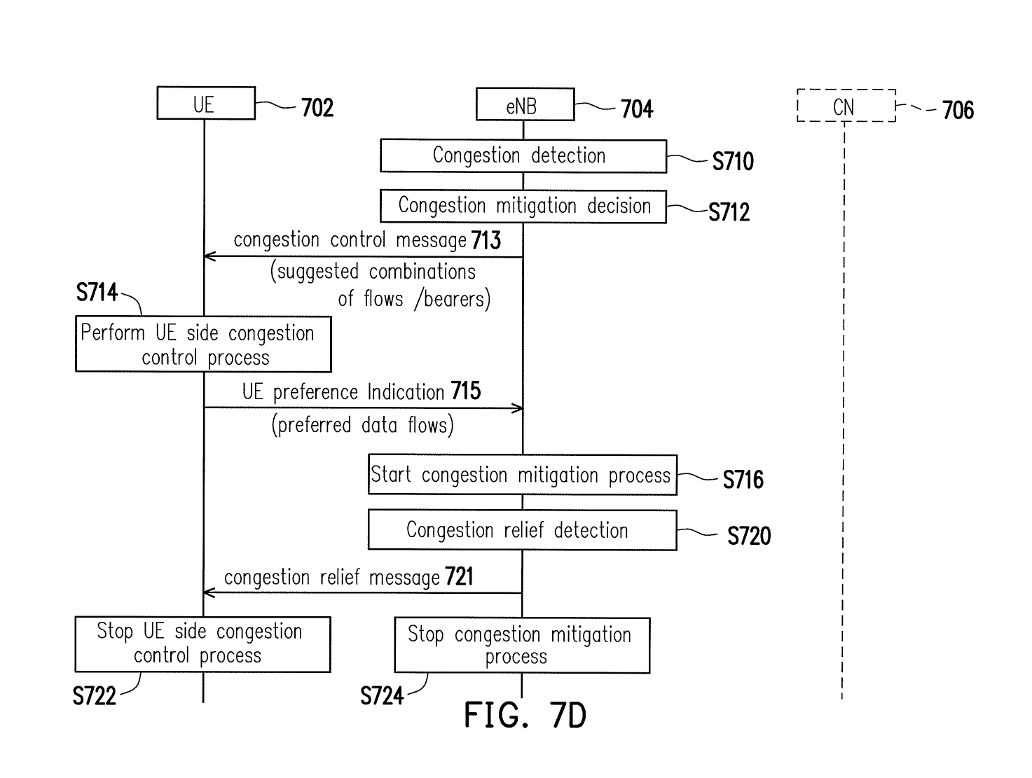

FIG. 7A shows the message diagram of the congestion management method according to one embodiment of the disclosure. In FIG. 7A, it illustrates a message diagram of one exemplary embodiment of a congestion management method with considering congestion control processes S714 and s718 in UE 702 and CN 706 respectively, where in UE 602 starts a first internal timer (e.g., internal prohibit timer) upon receiving a congestion control message 713 from eNB 704, and a congestion report message 717 without including suggested traffic flow/bearer configurations is sent from eNB 704 to CN after the eNB 704 determined the congestion mitigation method in the congestion mitigation decision process S712. The embodiment shown in FIG. 7A is similar to the embodiment shown in FIG. 6A, the difference between the embodiment shown in FIG. 7A and the embodiment shown in FIG. 6A is the congestion report message sent from the eNB to the CN. Specifically, the congestion report message 717 in FIG. 7A does not include the suggested traffic flow/bearer to the CN 706. The other processes and components shown in FIG. 7A can be interpreted by the corresponding processes and components in FIG. 6A

FIGS. 7B-7C show different exemplary embodiments of the congestion management method according to the disclosure. In FIG. 7B, it illustrates a message diagram of one exemplary embodiment of a congestion management method with considering the congestion control processes S714 and S718 in UE and CN sides respectively, wherein UE side starts a first internal timer (e.g., internal prohibit timer) upon receiving a congestion control message 713 from eNB 704, and congestion report message 711 without including suggested traffic flow/bearer configurations is sent from eNB 704 to CN 706 after the eNB 704 determined the congestion mitigation method in the congestion mitigation decision process S712. In FIG. 7C, it illustrates a message diagram of one exemplary embodiment of a congestion management method with considering the congestion control processes S714 and S718 in UE 704 and CN 706 respectively, wherein the UE side starts a first internal timer (e.g., internal prohibit timer) upon receiving a congestion control message 713 from eNB 704, and the congestion report message 711 without including suggested traffic flow/bearer configurations is sent from eNB 704 to CN 706 after the eNB 704 determined the congestion mitigation method in the congestion mitigation decision process S712. In detail, the congestion control message 711 in FIG. 7B is sent from the eNB 704 to the CN 706 after RAN DL UL congestion is detected and determined in the congestion detection process S710. In another embodiment as shown in FIG. 7C, the congestion report message 711 in FIG. 7C is sent from the eNB 704 to the CN 706 after the eNB 704 determined the congestion mitigation method in the congestion mitigation decision process S712.

In another embodiment of the disclosure as shown in FIG. 7D. In FIG. 7D, it illustrates a message diagram of one exemplary embodiment of a congestion management method without considering the congestion control processes in CN side. The embodiment as shown in FIG. 7D is similar to the embodiment as shown in FIG. 7A. The differences in comparing to the embodiment shown in FIG. 7A are that the CN side congestion control processes is not considered in the embodiment as shown in FIG. 7C. The eNB 704 neither send the congestion report message 711 nor the congestion relief message 721 to the CN 706. Moreover, in FIG. 7A shows an exemplary embodiment that the eNB 704 detected and determined the relief of RAN DL UP congestion in the process of congestion relief detection S720 and sent a congestion relief message 721 to the UE 702 before the expiry of the first internal timer (i.e., internal prohibit timer), wherein the UE 702 stops the first internal timer (i.e., internal prohibit timer) and stops the UE side congestion control process S722 upon receiving a congestion relief message 721 from eNB 704.

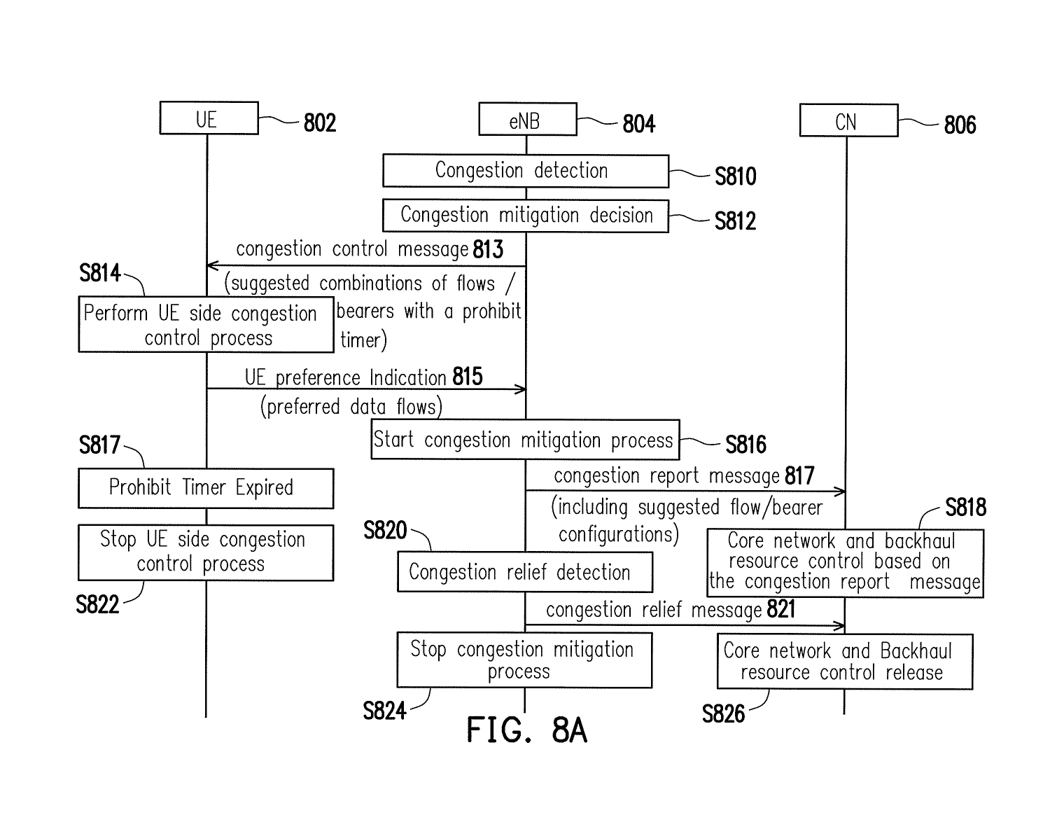

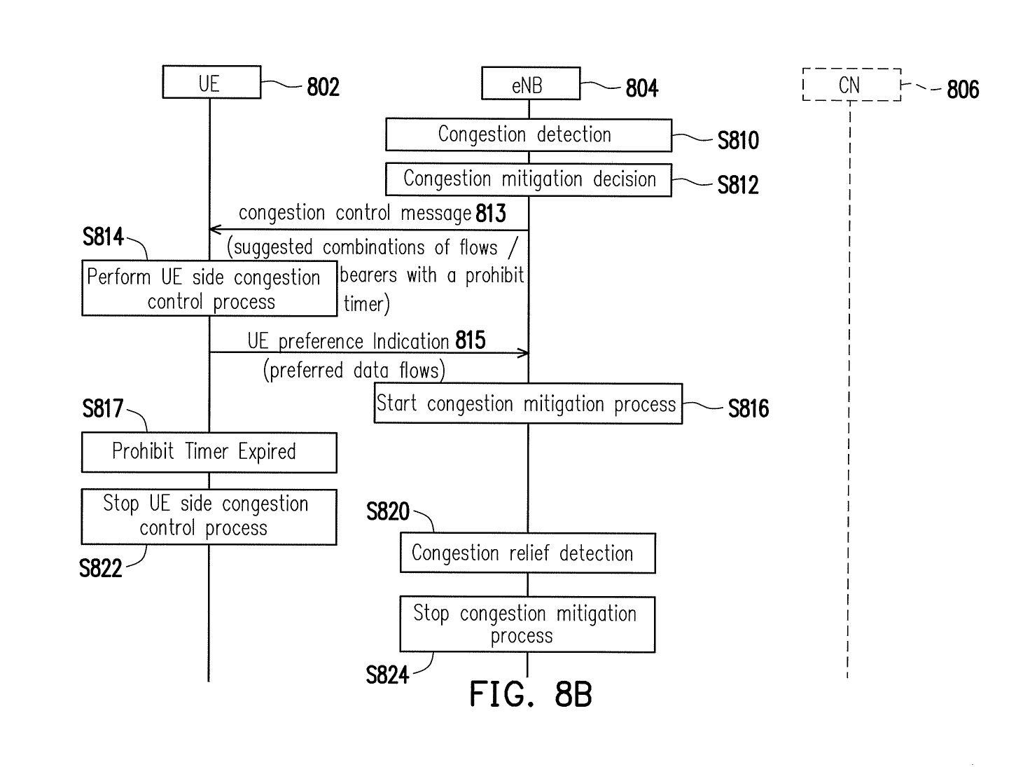

FIG. 8A shows a congestion management method according to another embodiment of the disclosure. In FIG. 8A, it illustrates one exemplary embodiment of a congestion management method with considering the congestion control processes S814 and S818 in UE 802 and CN 806 respectively, wherein a congestion control message 813 including the suggested combinations of traffic flow(s)/bearer(s) and a first timer (e.g., prohibit timer) is sent to the UE 802 from the eNB 804, and a congestion report message 817 is sent from the eNB 804 to the CN 806 including suggested traffic flow/bearer configurations from the eNB 804. Referring to FIG. 8A and FIG. 6A, the processes shown in FIG. 6A and FIG. 8A are similar except for the congestion control message 813 sent from the eNB 802 to the concerned UE 802. More specifically, while the congestion control message 613 shown in FIG. 6A does not include the first timer (e.g., prohibit timer), the congestion control message 813 shown in FIG. 8A includes the first timer (e.g., prohibit timer) to indicate the maximum period of time the UE 802 should be subjected to UE side congestion control. The UE 802 in FIG. 8A receives the first timer (i.e., prohibit timer) from the eNB 804, therefore the UE 802 may not start the first internal timer (i.e., internal prohibit timer) by the UE 802.

Another embodiment of the disclosure is shown in FIG. 8B. The embodiment as shown in FIG. 8B is similar to the embodiment as shown in FIG. 8A. In FIG. 8B the difference in comparing to the embodiment as shown in FIG. 8A is that the CN side congestion control processes are not been considered in the embodiment as shown in FIG. 8B. The eNB 804 may not send the congestion report message 817 and/or the congestion relief message 821 to the CN 806.

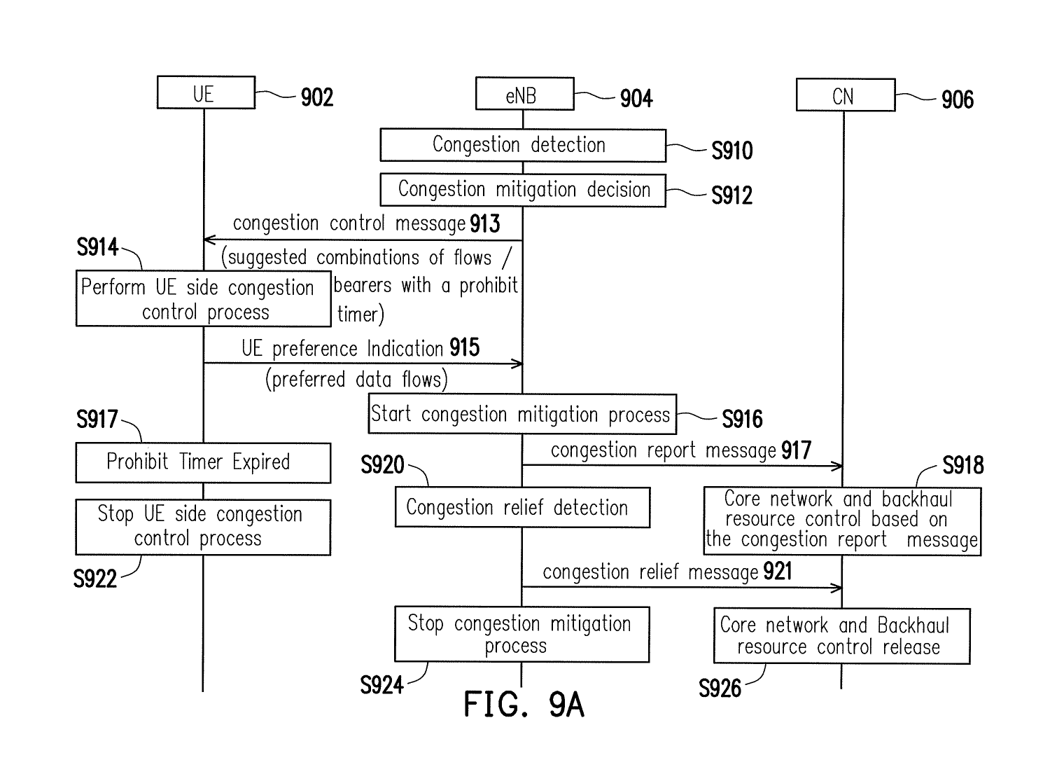

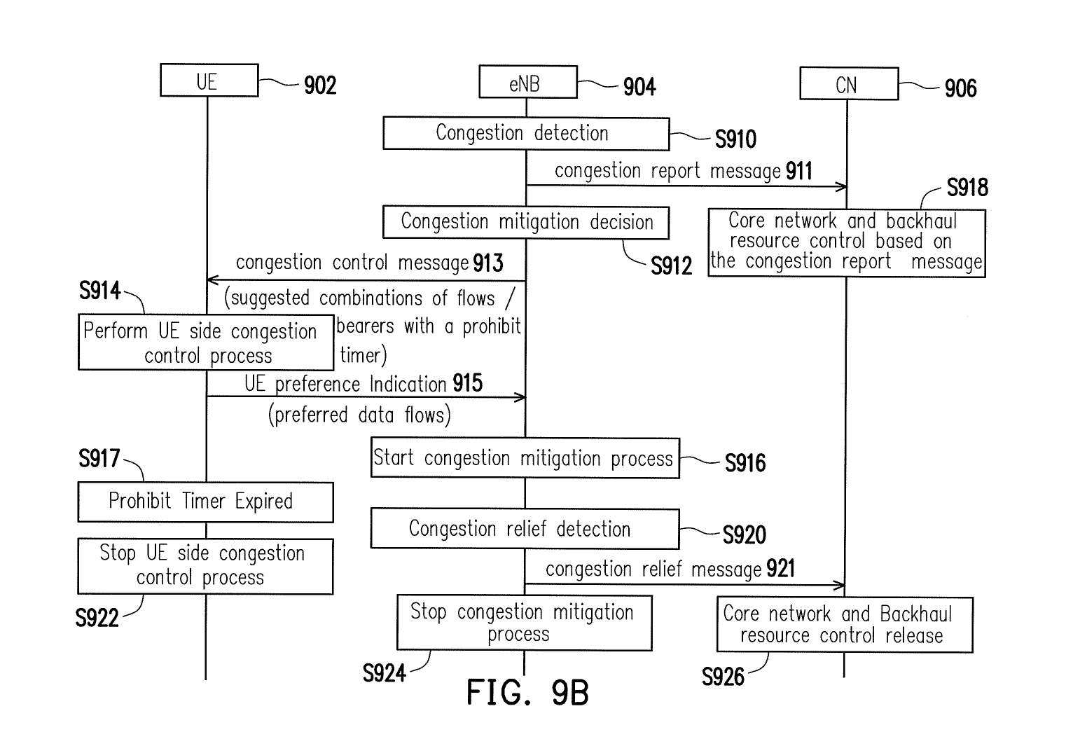

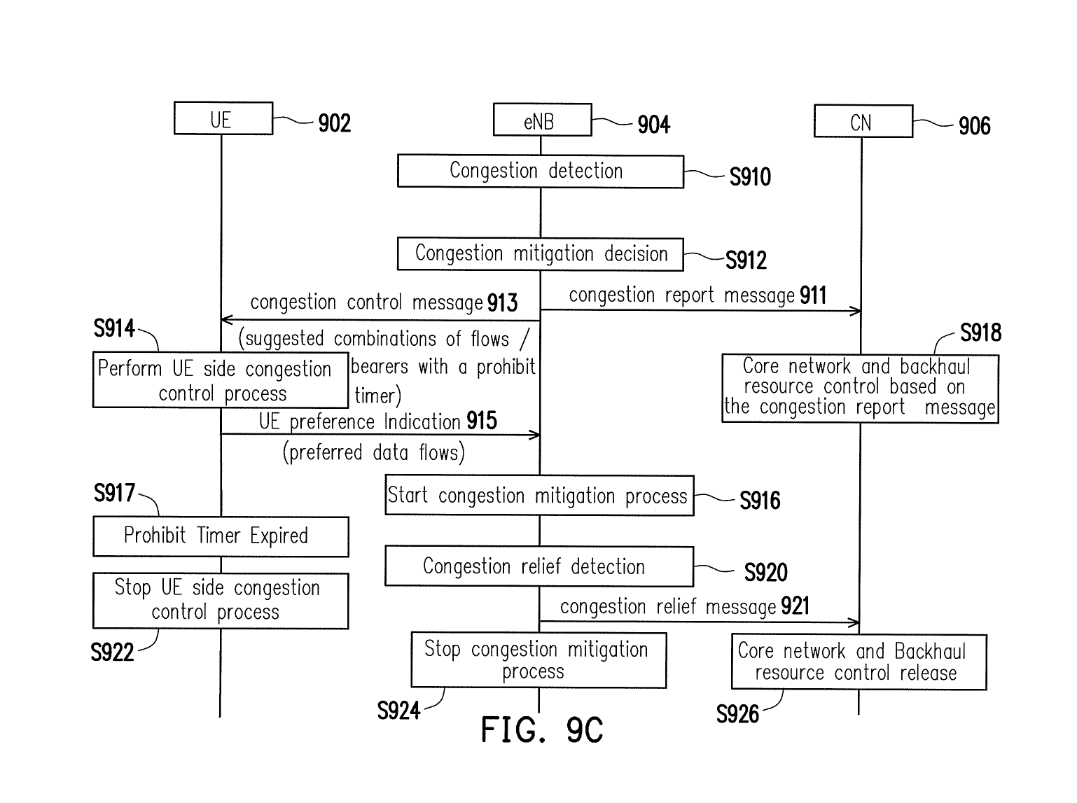

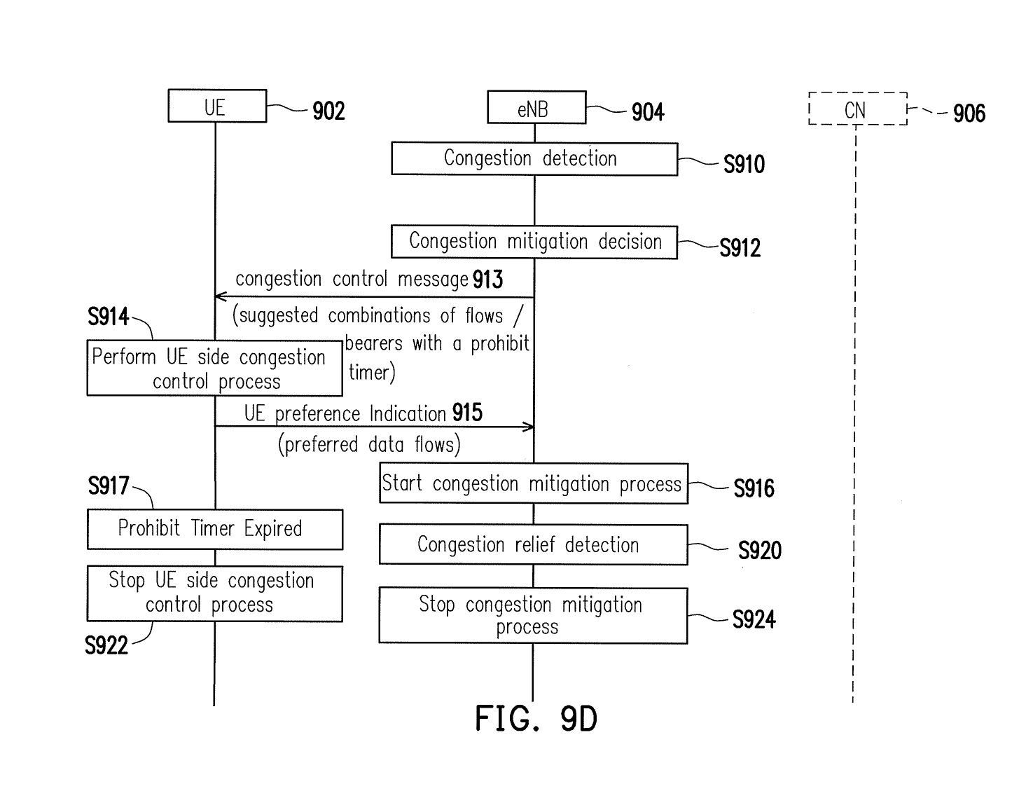

Please refer to FIG. 9A, which illustrates a message diagram of one exemplary embodiment of a congestion management method with considering congestion control processes S914 and S918 in UE 902 and CN 906 respectively, wherein a congestion control message 913 including the suggested combinations of traffic flow(s)/bearer(s) and a first timer (e.g., prohibit timer) is sent to UE 902 from eNB 904, and a congestion report message 917 without including suggested traffic flow/bearer configurations is sent from eNB 904 to CN 906 after the eNB 904 starts the congestion mitigation process S916. FIG. 9A is similar to the embodiment shown in FIG. 8A except that the congestion report message 917 in FIG. 9A sent from the eNB 904 to the CN 906 does not include the suggested traffic flow/bearer configuration to the CN 906.

FIG. 9B and FIG. 9C show different embodiments of the congestion management method according to the disclosure, wherein the conditions the congestion report messages are sent from the eNB 904 to the CN 906 are different in the embodiments of FIG. 9B and of FIG. 9C respectively. In FIG. 9B, it illustrates a message diagram of one exemplary embodiment of a congestion management method with considering congestion control processes S914 and S918 in UE 902 and CN 906 respectively, wherein the congestion control message 913 including the suggested combinations of traffic flow(s)/bearer(s) and a first timer (e.g., prohibit timer) is sent from eNB 904 to the UE 902, and a congestion report message 911 without including suggested traffic flow/bearer configurations from eNB 904 is sent to CN 906 after the eNB 904 detected and determined the RAN DL UP congestion in the congestion detection process 5910. In FIG. 9C, it illustrates a message diagram of one exemplary embodiment of a congestion management method with considering the congestion control processes S914 and S918 in UE 902 and CN 906 respectively, wherein a congestion control message including the suggested combinations of traffic flow(s)/bearer(s) and a first timer (e.g., prohibit timer) is sent to UE 902 from eNB 904, and a congestion report message 911 without including suggested traffic flow/bearer configurations is sent from eNB 904 to CN 906 after the eNB 904 determined the congestion mitigation method in the congestion mitigation decision process S912. In detail, the congestion report message 911 in FIG. 9B is sent to the CN 906 after the RAN DL UP congestion has been detected and determined by the eNB 904 in the congestion detection procedure S910. The congestion report message 911 in FIG. 9C is sent from the eNB 904 to the CN 906 after the eNB 904 determined the congestion mitigation method in the congestion mitigation decision process S912.

In another embodiment of the disclosure shown in FIG. 9D, it illustrates a message diagram of one exemplary embodiment of a congestion management method without considering congestion control processes in CN side, wherein a congestion control message 913 including a first timer (e.g., prohibit timer) is sent to UE from eNB 904. The differences in comparing to the embodiment shown in FIG. 9A are that the CN side congestion control processes are not considered in the embodiment of FIG. 9D. The eNB 904 may not send the congestion report message and/or the congestion relief message to the CN 906.

The various example embodiments described herein are described in the general context of the method and apparatus of UE assisted RAN-based RAN DL UP congestion control with considering UE preferences & backhaul resource saving. Specifically, the UE is allowed to feedback the preference of DL UP traffic flow(s)/bearer(s) to the network (including the RAN and the CN) and the eNB may suggest the configuration of traffic flow(s)/bearer(s) to the CN when RAN DL UP congestion has been detected and determined by the eNB.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A congestion management method, adapted for a radio access node, the method comprising:
detecting and determining a congestion;
performing a process of a congestion mitigation decision if the congestion is detected and determined;
performing a congestion mitigation process based on a result of the congestion mitigation decision;
detecting and determining a congestion relief; and
stopping the congestion mitigation process, a congestion control process according to the congestion being stopped.

2. The method of claim 1, wherein the congestion is detected and determined based on at least one statistic collected by the radio access node.

3. The method of claim 2, wherein the at least one statistic collected by the radio access node comprise at least one of performance indications of the radio access node.

4. The method of claim 3, wherein the one or more of performance indications of the radio access node comprises:
an average drop rate of all download flow buffers, or a ratio of requested transmission resource which is successfully scheduled to the transmission resource in a period of time, or a ratio that transmissions connections are abnormally loosed, or a throughput of each buffer, or a delay of each buffer, or any combination thereof.

5. The method of claim 1, wherein the process of the congestion mitigation decision comprises determining a mechanism to mitigate the congestion according to a policy and rules configured in the radio access node.

6. The method of claim 5, wherein the mechanism to mitigate the congestion comprises
decreasing radio resource allocated per user equipment (UE) for a portion or all of the UEs served by the radio access node,
suspending transmission of data packets associated to transmission connections with less precedence, or
throttling the transmission of the data packets associated to the transmission connections with less precedence, or
dropping the data packets associated to the transmission connections with less precedence.

7. The method of claim 1, further comprises:
selecting at least one concerned target traffic and the corresponding at least one concerned UE; and
sending a congestion control message to the concerned UE, and at least one preference indication is received from the concerned UE to indicate at least one preferred traffic flow/bearer of the concerned UE to the radio access node.

8. The method of claim 7, wherein the at least one preference indication is received by
signaling or broadcasting a congestion control message to the concerned UE, and
receiving a UE feedback from the concerned UE,
wherein the congestion control message comprises at least one target traffic, and
wherein the UE feedback comprises the at least one preference indication indicating at least one target traffic of the concerned UE.

9. The method of claim 8, wherein
the target traffic comprises at least one of combination of following: at least one traffic flow, at least one Radio Bearer (RB), or at least one service.

10. The method of claim 8, wherein the congestion control message further comprise at least one timer to indicate the concerned UE that the at least one preference indication shall be sent from the concerned UE to the radio access node before the timer is expired.

11. The method of claim 1 further comprises:
sending at least one congestion report message to a core network after the congestion is detected and determined by the radio access node, and
sending at least one congestion relief message to the core network after the congestion relief is detected and determined by the radio access node.

12. The method of claim 11, wherein the congestion report message further comprises:
at least one suggested UE, and
at least one suggested configuration of one or more target traffics.

13. A radio access node, comprising:
a transceiver configured to transmit and receive wireless signals; and
a processor coupled to the transceiver and configured to
detecting a congestion;
performing a process of a congestion mitigation decision if the congestion is detected and determined;
performing a congestion mitigation process based on a result of the congestion mitigation decision, a congestion control process being performed based on the result of the congestion mitigation decision according to the congestion that has been detected and determined; and
detecting a congestion relief,
wherein if the congestion relief is detected and determined, sending a congestion relief message and stopping the congestion mitigation process, the congestion control process according to the congestion being stopped.

14. The radio access node of claim 13, wherein the processor is further configured to select a concerned UE, and at least one preference indications is received from the concerned UE to indicate preferred traffic flows or bearers.

15. The radio access node of claim 14, wherein the at least one preference indication is received by
signaling or broadcasting a congestion control message to the concerned UE, and
receiving a UE feedback from the concerned UE,
wherein the UE feedback comprises the at least one preference indication indicating at least one preferred target traffic of the concerned UE.

16. The radio access node of claim 15, the congestion control message comprises at least one of following: at least one traffic flow, at least one RB, or at least one service; and
the preferred traffic flow/bearer comprises at least one of following: at least one traffic flow, at least one RB, or at least one service.

17. The radio access node of claim 15, wherein if the at least one preference indication is received from the concerned UE within a period of a timer, the congestion mitigation process use the at least one preference indication.

18. A congestion management method, adapted for a user equipment (UE), the method comprising:
receiving a congestion control message;
performing a congestion control process; and
generating a UE feedback in response to the congestion control message, wherein the UE feedback comprises at least one preference indication indicating at least a preferred target traffic of the UE.

19. The method of claim 18, further comprising:
sending a UE preference indication message including the at least one preference indication of the UE to a radio access node.

20. The method of claim 18, wherein the preferred traffic flow/bearer comprises at least one of following: at least one traffic flow, at least one RB, or at least one service.

21. The method of claim 18, further comprising
receiving a congestion relief message, and
terminating the congestion control process in response to the congestion relief message.

22. The method of claim 21, wherein a first timer is set by the congestion control message received.

23. The method of claim 21, wherein a first timer is set by the UE internally.

24. The method of claim 21, wherein within a period of a first timer, the UE is capable of sending at least one UE feedback in response to the congestion control message.

25. The method of claim 18, further comprising
a first timer in the UE is set in response to the congestion control message, and
when a period of time specified by the first timer is expired, terminating the congestion control process of the UE.

26. The method of claim 25, further comprising:
a second timer in the UE is set in response to the sending of UE preference indication message, wherein when a period of time specified by the second timer is not expired, the UE does not send UE preference indication message.

27. An user equipment (UE), comprising:
a transceiver configured to transmit and receive wireless signals; and
a processor coupled to the transceiver and configured to
receiving a congestion control message;
performing a congestion control process; and
generating a feedback in response to the congestion control message,
wherein the feedback comprises at least one preference indication indicating at least a preferred target traffic of the UE.
